(19) United States
(12) Patent Application Publication
(10) Pub. No.: US 2024/0403759 A1
(43) Pub. Date: Dec. 5, 2024

(54) SYSTEMS AND METHODS FOR LAB MANAGEMENT

(71) Applicants: Thermo Finnigan LLC, San Jose, CA (US); THERMO ELECTRON MANUFACTURING LIMITED, HEMEL HEMPSTEAD (GB); DIONEX CORPORATION, SUNNYVALE, CA (US)

(72) Inventors: Maximillian Spencer Hadfield, Hillsboro, OR (US); Tara L. Schroeder, Hillsboro, OR (US); Linda Xueying Lin, Hillsboro, OR (US); Misbah Rehman, Hillsboro, OR (US); Yu Cao, Hillsboro, OR (US); Helene L. Cardasis, Hillsboro, OR (US); Yu Zhou, Hillsboro, OR (US); Patrick Kenny, Hillsboro, OR (US); Waiming Yuen, Hillsboro, OR (US); Kevin Schauer, Hillsboro, OR (US)

(21) Appl. No.: 18/327,746

(22) Filed: Jun. 1, 2023

(51) Int. Cl. G06Q 10/0631

(52) U.S. Cl. CPC G06Q 10/06314

(57) ABSTRACT

Disclosed herein are scientific instrument support systems, as well as related methods, computing devices, and computer-readable media. For example, in some embodiments, a support system is provided for a scientific instrument. The support system is configured to acquire, for each of a plurality of scientific instrument groups, asset information associated with the scientific instrument group. The scientific instrument group includes at least one scientific instrument. The support system is also configured to acquire, for each of the plurality of scientific instrument groups, reservation information associated with the scientific instrument group. The support system is also configured to generate, for each of the plurality of scientific instrument groups, a status card including status information associated with the scientific instrument group. The status information is at least based on the asset information and the reservation information. The support system is configured to provide a first user interface for displaying the status cards.

### BACKGROUND

Scientific instruments may include a complex arrangement of movable components, sensors, input and output ports, energy sources, and consumable components. Lab systems may include many instruments and many individuals interacting with different instruments.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, not by way of limitation, in the figures of the accompanying drawings.

FIG. 1 is a block diagram of an example scientific instrument support system, in accordance with various embodiments.

FIG. 2 is a block diagram of an example scientific instrument support module for performing lab management operations, in accordance with various embodiments.

FIG. 3 is a block diagram of an example server-based platform for performing lab management, in accordance with various embodiments.

FIG. 4A is an example instrument status card that may be displayed in a graphical user interface, in accordance with various embodiments.

FIG. 4B is an example instrument status card that may be displayed in a graphical user interface, in accordance with various embodiments.

FIG. 4C is an example instrument status card that may be displayed in a graphical user interface, in accordance with various embodiments.

FIG. 4D is an example instrument status card that may be displayed in a graphical user interface, in accordance with various embodiments.

FIG. 5 is an example graphical user interface for displaying a status of a plurality of scientific instrument groups, in accordance with various embodiments.

FIG. 6 is an example graphical user interface for displaying system details of a scientific instrument group, in accordance with various embodiments.

FIG. 7 is an example graphical user interface for displaying a logbook for a scientific instrument group, in accordance with various embodiments.

FIG. 8 is an example graphical user interface for requesting support for a scientific instrument, in accordance with various embodiments.

FIG. 9 is an example graphical user interface for opening a new ticket for a scientific instrument, in accordance with various embodiments.

FIG. 10 is an example workflow for opening a support ticket for a scientific instrument, in accordance with various embodiments.

FIG. 11 is an example graphical user interface for displaying an aggregated reservation schedule of a plurality of scientific instrument groups, in accordance with various embodiments.

FIG. 12 is an example reservation editor panel that may be displayed in a scheduler graphical user interface, in accordance with various embodiments.

FIG. 13A is an example reservation editor panel that may be displayed in a scheduler graphical user interface, in accordance with various embodiments.

FIG. 13B is an example reservation editor panel that may be displayed in a scheduler graphical user interface, in accordance with various embodiments.

FIG. 14 is an example view displayed in a scheduler user interface for creating a new reservation, in accordance with various embodiments.

FIG. 15 is an example scheduler graphical user interface including a reservation details panel, in accordance with various embodiments.

FIG. 16 is an example scheduler graphical user interface with reservation schedules grouped by assignee, in accordance with various embodiments.

FIG. 17 is an example scheduler graphical user interface including an instrument editor panel, in accordance with various embodiments.

FIG. 18 is an example scheduler user interface including a data export panel, in accordance with various embodiments.

FIG. 19 is an example user settings graphical user interface, in accordance with various embodiments.

FIG. 20 is a flow diagram of an example method of performing lab management operations, in accordance with various embodiments.

FIG. 21 is an example of a graphical user interface that may be used in the performance of some or all of the lab management methods disclosed herein, in accordance with various embodiments.

FIG. 22 is a block diagram of an example computing device that may perform some or all of the scientific instrument support methods disclosed herein, in accordance with various embodiments.

FIG. 23 is a block diagram of an example scientific instrument support system in which some or all of the scientific instrument support methods disclosed herein may be performed, in accordance with various embodiments.

### DETAILED DESCRIPTION

Disclosed herein are scientific instrument support systems, as well as related methods, computing devices, and computer-readable media. For example, in some embodiments, a support system is provided for a scientific instrument. The support system is configured to acquire, for each of a plurality of scientific instrument groups, asset information associated with the scientific instrument group. The scientific instrument group includes at least one scientific instrument. The support system is also configured to acquire, for each of the plurality of scientific instrument groups, reservation information associated with the scientific instrument group. The support system is also configured to generate, for each of the plurality of scientific instrument groups, a status card including status information associated with the scientific instrument group. The status information is at least based on the asset information and the reservation information. The support system is also configured to provide a first user interface for displaying the status cards. The status information provided via the support system may include real-time status and data, including but not limited to, instrument status, service support ticket status, data acquisition status, sample analysis results, a prediction of a remaining time to complete a data acquisition queue, or a combination thereof.

The scientific instrument support embodiments disclosed herein may achieve improved lab management relative to conventional approaches. For example, as scientific laboratories increase in size, lab managers, scientists, and technicians experience difficulty viewing, monitoring, and managing instruments in a lab. Additionally, instruments and devices used for experiments may be located in different laboratories, adding communication latency to experiment time and status updates. Because each lab may include many individuals working in the lab, lab managers may experience issues determining availability of resources (such as, for example, instruments), and communicating instrument reservation status. Additionally, the growing complexity of labs causes issues for laboratory managers in identifying which devices require maintenance, remotely troubleshooting instruments, and communicating the nonoperational status of those instruments. Embodiments disclosed herein address these and other issues and, therefore, provide improvements to scientific instrument technology (e.g., improvements in the computer technology supporting such scientific instruments, among other improvements).

For example, embodiments disclosed herein provide, among other things, a platform for detecting and visualizing instrument status (e.g., operational status and data acquisition status), organizing both instruments and users of instruments according to availability and usability, viewing project status, managing project plans, or a combination thereof. Additionally, among other things, various ones of the embodiments disclosed herein may provide improvements to graphical user interface (GUI) technology. For example, GUIs provided herein provide an organized view of the status of all components (e.g., devices and scientific instruments) within a support system, as well as the availability of those instruments, which increases the efficiency the reserving and implementing projects on one or more instruments and associated computing and instrument usage.

Various ones of the embodiments disclosed herein may improve upon conventional approaches to achieve the technical advantages of improved lab management and, consequently, improved operation of scientific instruments. Such technical advantages are not achievable by routine and conventional approaches, and all users of systems including such embodiments may benefit from these advantages (e.g., by assisting the user in the performance of a technical task, such as monitoring instrument data acquisition and operational status, by means of a guided human-machine interaction process). The technical features of the embodiments disclosed herein are thus decidedly unconventional in the field of lab management, as are the combinations of the features of the embodiments disclosed herein. The computational and user interface features disclosed herein do not only involve the collection and comparison of information but apply new analytical and technical techniques to change the management of instrument support systems. The present disclosure thus introduces functionality that neither a conventional computing device, nor a human, could perform.

Accordingly, the embodiments of the present disclosure may serve any of a number of technical purposes, such as managing a specific technical system or process; determining machine or instrument availability or status; optimizing load distribution in a computer network (e.g., by distributing projects and associated data processing across instruments included in one or more labs); or providing a faster processing of sensor data (e.g., by identifying available machine or instruments and associated data processing); or a combination thereof.

The embodiments disclosed herein thus provide improvements to lab and instrument management technology (e.g., improvements in the computer technology supporting scientific instruments, among other improvements).

In the following detailed description, reference is made to the accompanying drawings that form a part hereof wherein like numerals designate like parts throughout, and in which is shown, by way of illustration, embodiments that may be practiced. It is to be understood that other embodiments may be utilized, and structural or logical changes may be made, without departing from the scope of the present disclosure. Therefore, the following detailed description is not to be taken in a limiting sense.

Various operations may be described as multiple discrete actions or operations in turn, in a manner that is most helpful in understanding the subject matter disclosed herein. However, the order of description should not be construed as to imply that these operations are necessarily order dependent. In particular, these operations may not be performed in the order of presentation. Operations described may be performed in a different order from the described embodiment. Various additional operations may be performed, and/or described operations may be omitted in additional embodiments.

For the purposes of the present disclosure, the phrases “A and/or B” and “A or B” mean (A), (B), or (A and B). For the purposes of the present disclosure, the phrases “A, B, and/or C” and “A, B, or C” mean (A), (B), (C), (A and B), (A and C), (B and C), or (A, B, and C). Although some elements may be referred to in the singular (e.g., “a processing device”), any appropriate elements may be represented by multiple instances of that element, and vice versa. For example, a set of operations described as performed by a processing device may be implemented with different ones of the operations performed by different processing devices.

The description uses the phrases “an embodiment,” “various embodiments,” and “some embodiments,” each of which may refer to one or more of the same or different embodiments. Furthermore, the terms “comprising,” “including,” “having,” and the like, as used with respect to embodiments of the present disclosure, are synonymous. When used to describe a range of dimensions, the phrase “between X and Y” represents a range that includes X and Y. As used herein, an “apparatus” may refer to any individual device, collection of devices, part of a device, or collections of parts of devices. The drawings are not necessarily to scale.

Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

It should also be understood that although certain drawings illustrate hardware and software located within particular devices, these depictions are for illustrative purposes only. In some embodiments, the illustrated components may be combined or divided into separate software, firmware, and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links.

Thus, in the claims, if an apparatus or system is claimed, for example, as including an electronic processor or other element configured in a certain manner, for example, to make multiple determinations, the claim or claim element should be interpreted as meaning one or more electronic processors (or other element) where any one of the one or more electronic processors (or other element) is configured as claimed, for example, to make some or all of the multiple determinations. To reiterate, those electronic processors and processing may be distributed.

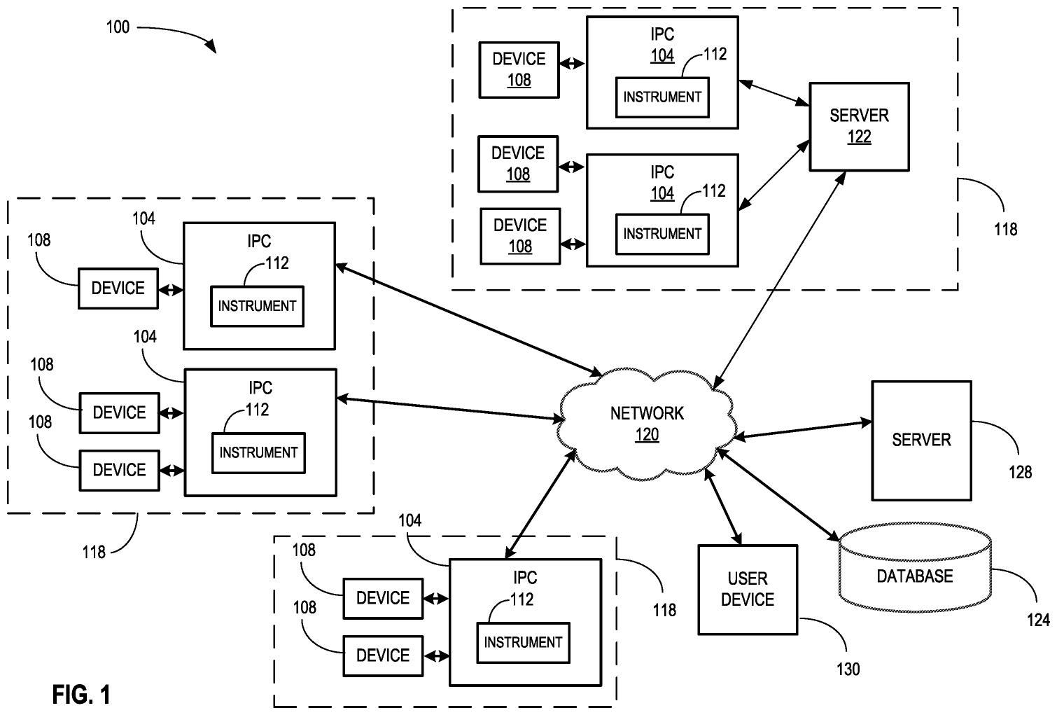

FIG. 1 is a block diagram of a scientific instrument support system 100 (henceforth referred to simply as support system 100) for performing support operations, in accordance with various embodiments. As illustrated in FIG. 1, the support system 100 includes a plurality of instrument personal computer (IPC) s 104 connected over a communication connection or network 120. One or more devices 108 are connected to each IPC 104. Devices 108 are physical entities that perform some function of sample preparation and/or sample analysis. For example, devices 108 may be physical devices having a serial number, a means of communicating with other external entities, and may include processors, memory, and firmware. Devices 108 may include, for example, sensors, detectors, actuators, spectrometers, spectrograms, oscilloscopes, electrometers, interferometers, and the like. The IPCs 104 may also include one or more instruments 112. Instruments 112 are logical containers that include a collection of devices 108. For example, devices 108 work together to perform operations and produce results. The logical collection of devices 108 (e.g., the instrument 112) prepares or analyzes inputs, such as blood samples or other biological samples, semiconductors, chemical compounds, solutions, food and drug samples, and the like. Each IPC 104 is connected to its respective device(s) 108 and may be configured to communicate uni-directionally or bi-directionally with the connected device(s) 108. Each IPC 104 may be connected to the device(s) 108 via wired or wireless communication mediums and/or protocols. Each IPC 104 may transmit commands to the connected device(s) 108, receive status signals from the device(s) 108, receive measurements from the device(s) 108, and the like, as described below in more detail. The IPCs 104, and their corresponding connected device(s) 108, may be organized into a plurality of scientific instrument groups 118. For example, a scientific instrument group 118 may include a liquid chromatography (“LC”) instrument IPC 104 and a mass spectrometry (“MS”) IPC 104, or a group 118 may include a LC device 108 and a MS device 108, which are connected to an IPC 104, wherein the combination constitutes or represents an instrument 112 as described herein. As illustrated in FIG. 1, an instrument group 118 can include a standalone workstation IPC 104 or a group of IPCs 104 connected to an enterprise server 122. Each scientific instrument group 118 includes at least one IPC 104. The IPCs 104, the devices 108, and the instruments 112 may be more generally referred to as service components. The instruments 112 may include, for example, liquid chromatography instruments, gas chromatography instruments, ion chromatography instruments, mass spectrometry instruments, trace elemental instruments (e.g., inductively coupled plasma mass spectrometry, inductively coupled plasma optical emission spectroscopy, atomic absorption, etc.), capillary electrophoresis instruments, spectroscopy instruments, and the like. However, it should be understood that instruments 112 are not limited to those described herein, and other types of instruments are contemplated. For example, any type of instrument configured to follow or interact with the defined user interfaces may be supported and may be automatically detected (as described below) and managed within the system 100. Furthermore, as also described in more detail below, in some embodiments, the system 100 is configured to enable a user to manually add an instrument for management within the system 100.

The support system 100 includes a database 124, a server 128, and a user device 130 communicatively coupled with the plurality of IPCs 104 (and with each other) through the communication network 120. In other embodiments, the plurality of IPCs 104, the server 128, and the database 124 communicate via one or more dedicated wire connections or other forms of wired or wireless electronic communication. It should be understood that the support system 100 may include fewer or additional components than those illustrated in FIG. 1. For example, the support system 100 may include fewer or more IPCs 104, multiple servers 128, multiple databases 124, or a combination thereof. In some instances, rather than including an independent database, the storage functionality of the database 124 is provided by the server 128. The components of the support system 100 may also communicate through one or more intermediary devices not illustrated in FIG. 1.

The server 128 serves as a “control hub” for the plurality of IPCs 104. For example, the server 128 communicates with each of the IPCs 104 by sending commands to the IPCs 104 to perform methods described herein over a wired connection, a wireless connection, or a combination thereof. Additionally, the server 128 receives measurements and statuses of device(s) 108 and instrument(s) 112 from their respective IPCs 104 over a wired connection, wireless connection, or a combination thereof. The database 124 stores data indicating the status of components within the support system 100. For example, the database 124 may store a current status of the device(s) 108 and instrument(s) 112, historical statuses of the device(s) 108 and instrument(s) 112, measurements recorded by the device(s) 108 and instrument(s) 112, and the like.

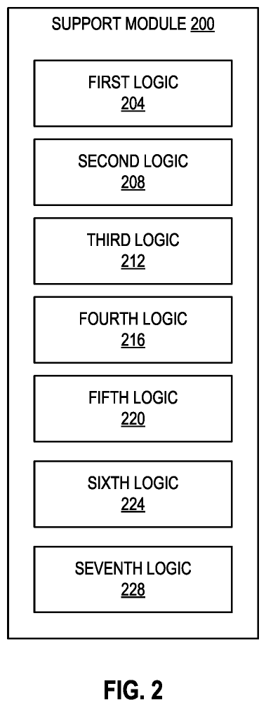

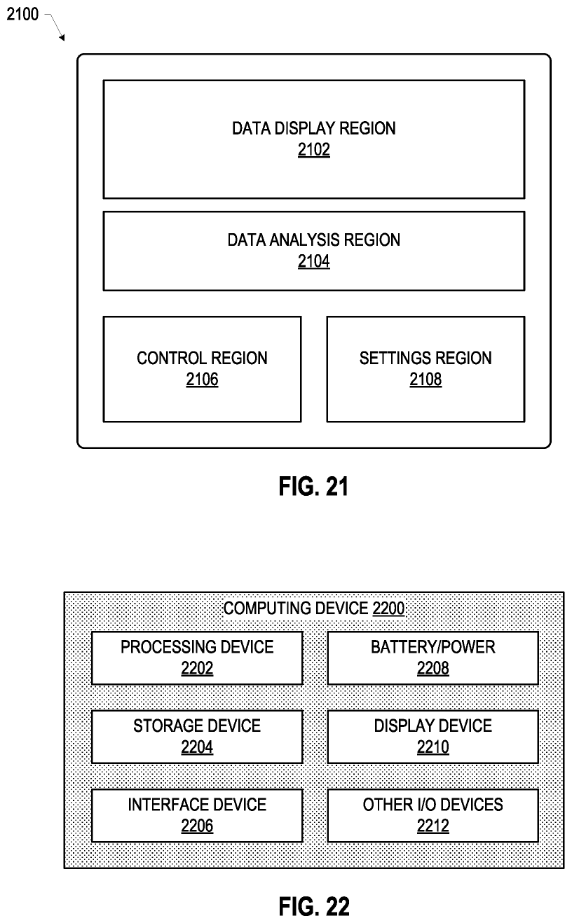

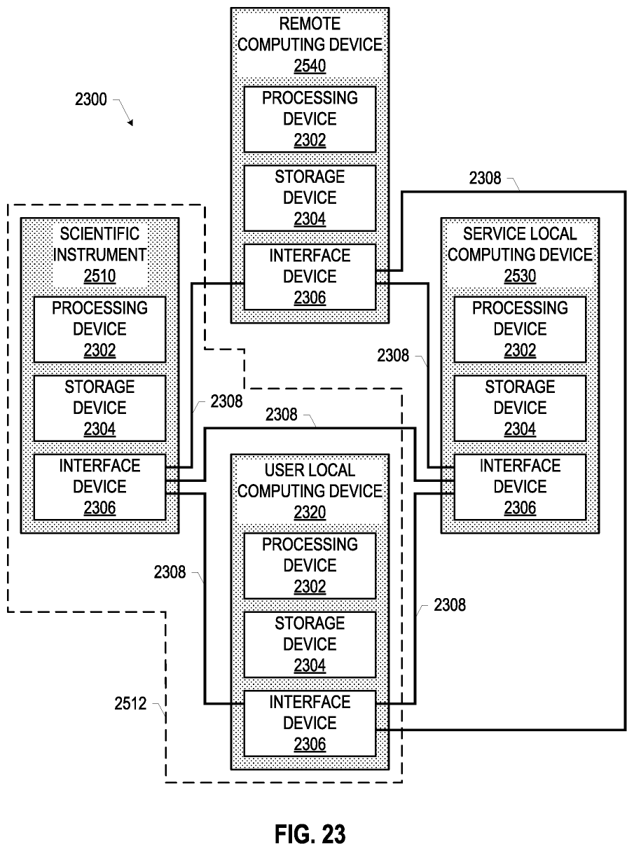

FIG. 2 is a block diagram of a scientific instrument support module 200 for performing support operations, in accordance with various embodiments. The scientific instrument support module 200 may be, for example, the server 128. The scientific instrument support module 200 may be implemented by circuitry (e.g., including electrical and/or optical components), such as a programmed computing device. The logic of the scientific instrument support module 200 may be included in a single computing device or may be distributed across multiple computing devices that are in communication with each other as appropriate. Examples of computing devices that may, singly or in combination, implement the scientific instrument support module 200 are discussed herein with reference to the computing device 2200 of FIG. 22, and examples of systems of interconnected computing devices, in which the scientific instrument support module 200 may be implemented across one or more of the computing devices, is discussed herein with reference to the scientific instrument support system 2300 of FIG. 23.

The scientific instrument support module 200 may include first logic 204, second logic 208, third logic 212, fourth logic 216, fifth logic 220, sixth logic 224, and seventh logic 228. As used herein, the term “logic” may include an apparatus that is to perform a set of operations associated with the logic. For example, any of the logic elements included in the support module 200 may be implemented by one or more computing devices programmed with instructions to cause one or more processing devices of the computing devices to perform the associated set of operations. In a particular embodiment, a logic element may include one or more non-transitory computer-readable media having instructions thereon that, when executed by one or more processing devices of one or more computing devices, cause the one or more computing devices to perform the associated set of operations. As used herein, the term “module” may refer to a collection of one or more logic elements that, together, perform a function associated with the module. Different ones of the logic elements in a module may take the same form or may take different forms. For example, some logic in a module may be implemented by a programmed general-purpose processing device, while other logic in a module may be implemented by an application-specific integrated circuit (ASIC). In another example, different ones of the logic elements in a module may be associated with different sets of instructions executed by one or more processing devices. A module may not include all of the logic elements depicted in the associated drawing; for example, a module may include a subset of the logic elements depicted in the associated drawing when that module is to perform a subset of the operations discussed herein with reference to that module.

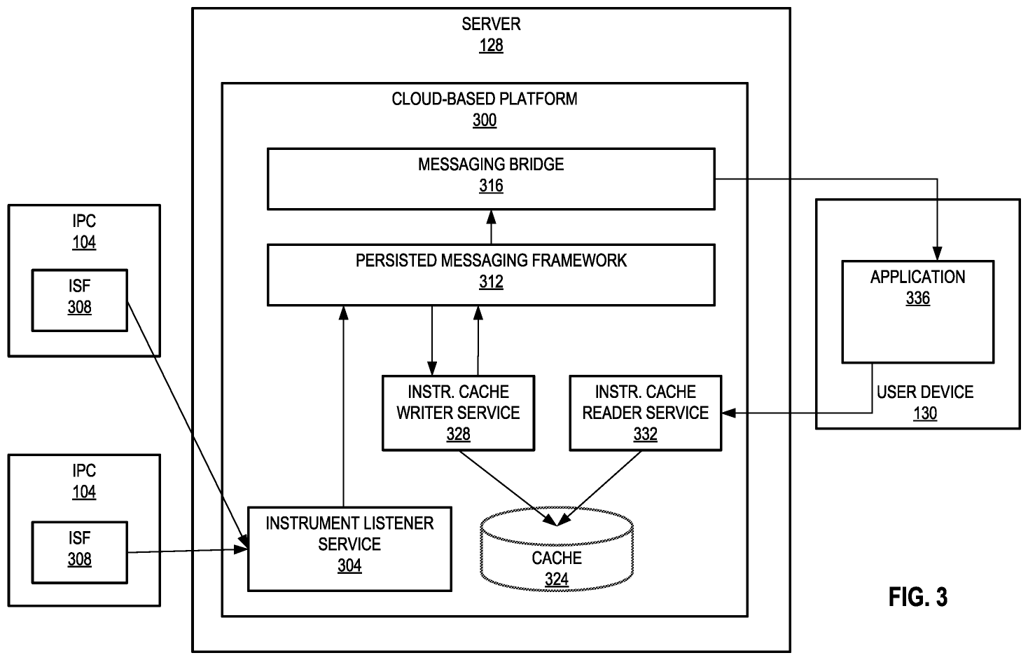

The first logic 204 may be configured to acquire, for each of the plurality of scientific instrument groups 118, asset information associated with the scientific instrument group 118. For example, FIG. 3 is a block diagram illustrating asset information acquisition using a server-based platform 300 supported by the server 128, according to some examples. The server-based platform 300 may be implemented as a cloud-based platform or using a private server (e.g., on the premises of a lab). The server-based platform 300 may include an instrument listener service (“ILS”) 304 communicatively coupled (e.g., over the network 120) to an instrument service façade (“ISF”) 308 included in each IPC 104 associated with an instrument 112. The ILS 304 receives, using the ISF 308, asset information associated with assets of each IPC 104, such as, for example, the device(s) 108, the instrument 112, or other components of each IPC 104. The asset information may include an identifier of an instrument associated with the IPC 104 or the instrument 112 (a type identifier, a unique identifier, or a combination thereof), a network connection status of the IPC 104, realtime data acquisition status of the IPC 104, instrument configuration information, a scientific instrument group identifier, an owner of the instrument 112, a model of the instrument, a lab name associated with the scientific instrument group 118, a location of the scientific instrument group 118, or a combination thereof. In some embodiments, an instrument group may be modified as labs and instruments change. For example, an instrument group may be modified to be associated with a different lab or to be associated with multiple labs. The realtime data acquisition status may include a status of an operation currently being performed, previously performed, or pending performance by the device(s) 108, the IPC 104, the instrument 112, or a combination thereof. The asset information may also include device details associated with each device 108 such as, for example, a device name, a device serial number, a device model number, a device firmware version, a device warranty expiration date, a device warranty status, a device service provider, a service status, a contract expiration date, or a combination thereof. The asset information may also include other status logs associated with the device(s) 108, the IPC 104, and/or the instrument 112, such as, for example, error logs or operation history.

In some instances, each instrument 112, IPC 104, or both has one or more connectivity services installed, such as, for example, an instrument service façade service, a device integration service, a device registry service, a proxy client service, or a combination thereof that listens to instrument changes and reports such instrument changes to the instrument listener service 304 installed on the server 128. For example, a proxy client service can be installed and running in each IPC 104 to send information from each IPC 104 to a proxy server service running in the server 128 that will route the information to other services running in the server 128, such as, for example, the ILS 204.

The server-based platform 300 may also include a persisted messaging framework (“PMF”) 312 and a messaging bridge 316. The ILS 304 publishes the acquired asset information from each IPC 104 to the PMF 312. The server-based platform 300 also includes a cache 324, an instrument cache writer service (“ICWS”) 328, and an instrument cache reader service (“ICRS”) 332. The PMF 312 outputs the asset information of the asset information to the ICWS 328, which in turn writes the asset information (e.g., the data acquisition status) to the cache 324. The ICWS 328 also publishes the asset information to the PMF 312 on a per instrument basis, a per IPC basis, and/or a per device basis. The PMF 312 outputs the asset information to the messaging bridge 316, which enables the server 128 to provide the asset information to, for example, a user application 336 (e.g., a desktop application, a mobile application, a web-browser application, etc.). Using the ICRS 332 of the server-based platform 300, the application 336 may receive additional asset information stored in the cache 324. The application 336 is configured (e.g., when executed) to display some or all of the user interfaces described herein on the user device 130.

Some or all of the asset information described above may be acquired using, for example, the ILS 304 of the server-based platform 300. For example, in some instances, the ILS 304 only acquires a data acquisition status associated with each IPC 104, and the server-based platform 300 is configured to read other asset information (e.g., scientific instrument group names, lab names, locations, etc.) from the database 124. The server-based platform 300 may be configured to update asset information in the database 124 according to, for example, user input received through the application 336.

The second logic 208 may be configured to acquire, for each of the plurality of scientific instrument groups 118, reservation information associated with the scientific instrument group 118. For example, the database 124 may store reservation information for each of the scientific instrument groups 118. The reservation information includes scheduling data associated with the planned availability of each scientific instrument group 118. The reservation information may include, for example, a reservation start date and time, a reservation end date and time, a reservation name, a reservation assignee (e.g., a scientist or technician in the lab that owns the reservation), or the like. The reservation information may also include a project identifier associated with a reservation.

The third logic 212 may be configured to generate, for each of the plurality of scientific instrument groups 118, a status card including status information associated with the scientific instrument group. The status information is at least based on the asset information and the reservation information. For example, the status information may include a plot (e.g., a chromatogram) representing the data acquisition status (also referred to herein as a mini plot as it may represented a condensed, miniaturized, or summarized version of other available plots), realtime status information, sample analysis results, number of remaining samples to run, a prediction of a remaining time to complete the data acquisition queue, or a combination thereof.

In some instances, the third logic 212 generates a status card for each scientific instrument group 118, individual IPCs 104, individual instruments 112, and/or individual devices.

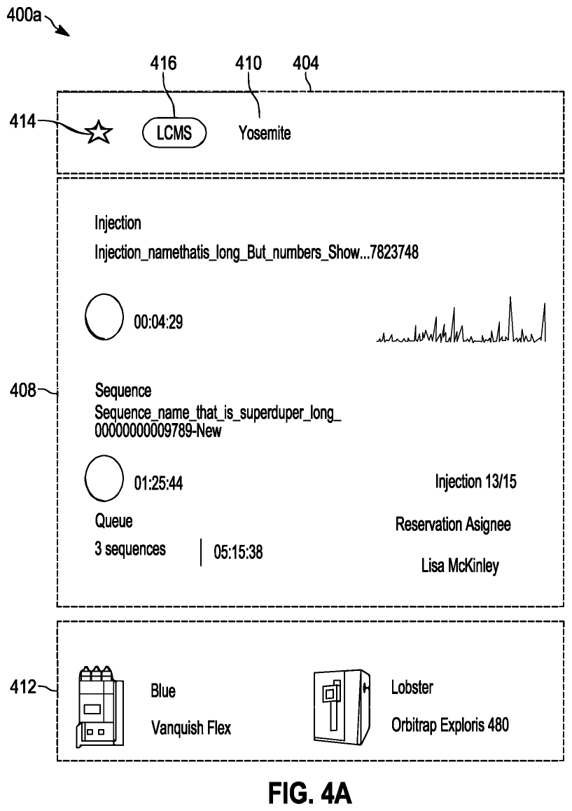

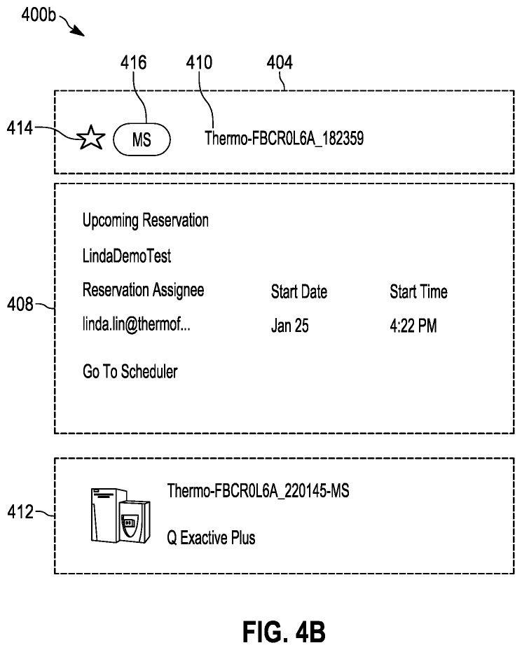

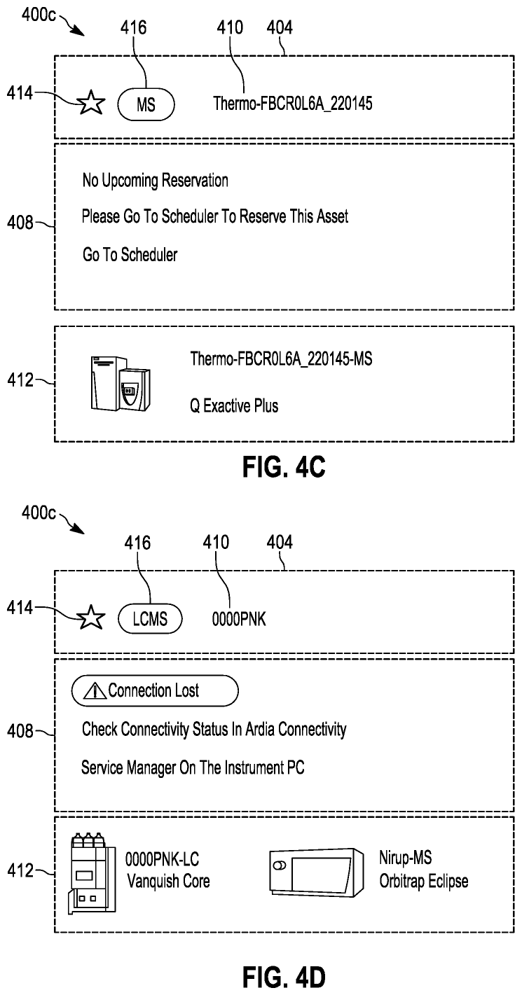

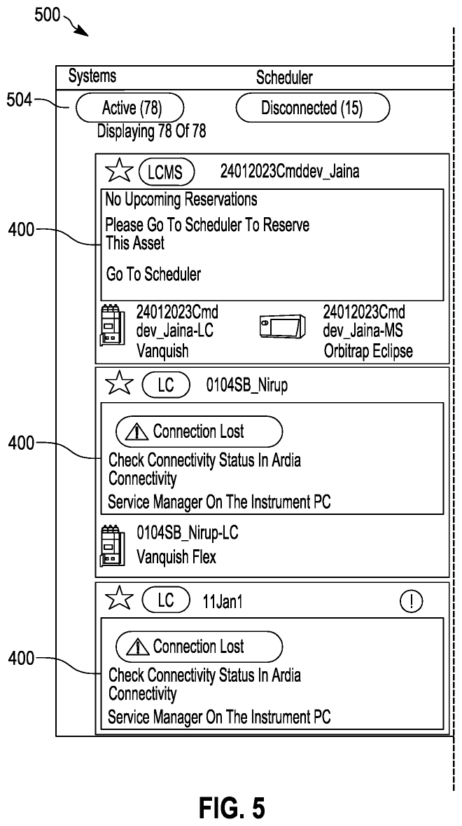

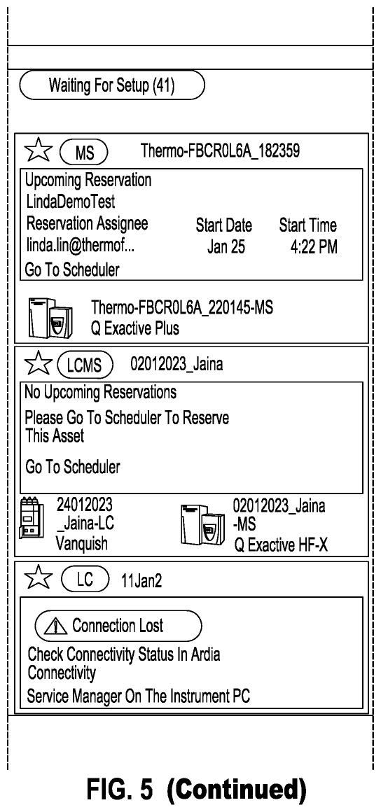

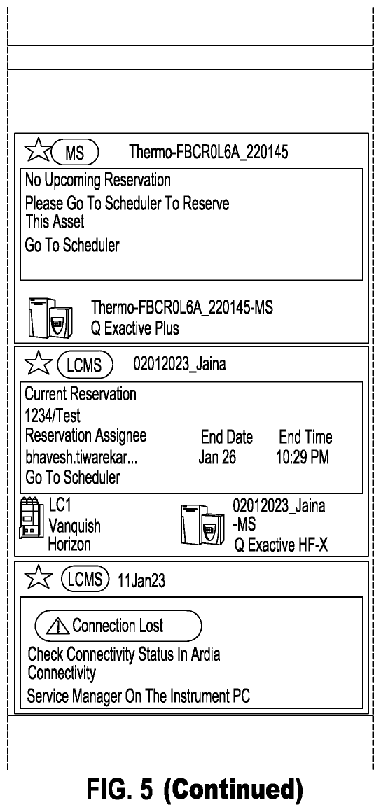

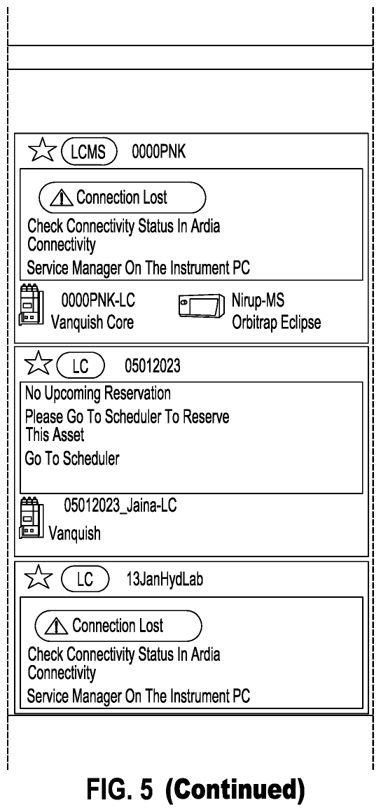

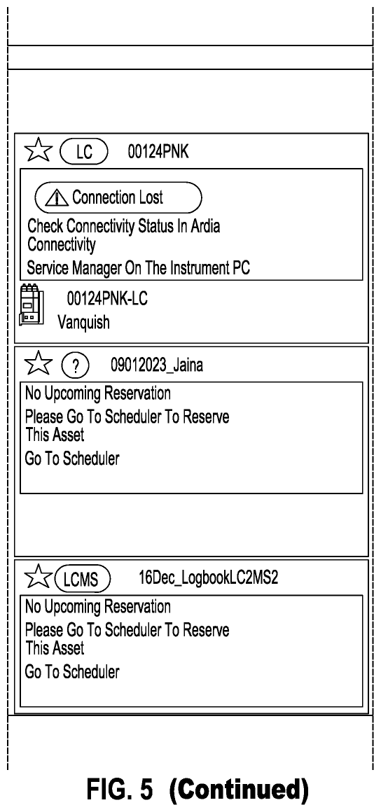

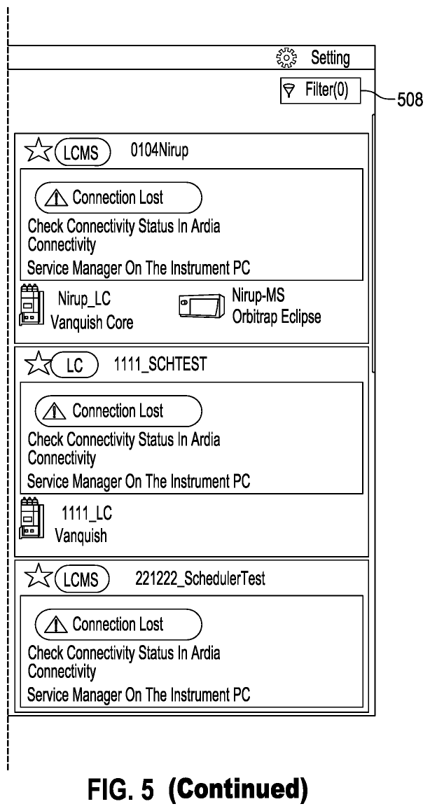

FIG. 4A illustrates a first example of a status card 400a generated by the third logic 212. The status card 40a may include a scientific instrument group indicator portion 404, a reservation status portion 408, and an instrument configuration portion 412. The scientific instrument group indicator portion 404 may include a pinned group indicator 414 (otherwise referred to as favorites indicator 414), group configuration indicator 416, a scientific instrument group name 410, or a combination thereof. The pinned group indicator 414 indicates whether the status card 400 is pinned to the top of a display region of a user interface (e.g., the asset view user interface described in greater detail below with respect to FIG. 5). In response to receiving user input (e.g., through the application 336) selecting the pinned group indicator 414 associated with a scientific instrument group 118, the third logic 212 may toggle the status of the pinned group indicator 414.

The group configuration indicator 416 includes a user-defined indicator for describing, for example, a configuration of the scientific instrument group. In the illustrated example, the group configuration indicator 416 indicates (through the representation “LCMS”) that the instruments 112 and/or IPCs 104 included in the scientific instrument group 118 correspond to a light spectrometer (LC) and a mass spectrometer (MS). The scientific instrument group name 410 is, for example a user-defined name of the scientific instrument group 118, for example, “Yosemite” in the example illustrated in FIG. 4A.

The reservation status portion 408 includes information relating to a status of a reservation of the scientific instrument group 118. During an ongoing reservation, for example, the reservation status portion 408 may include a description of one or more operations currently being performed by device(s) 108 in the scientific instrument group 118. For example, as illustrated in FIG. 4A, the reservation status portion 408 may include, for each operation being performed by the scientific instrument group 118, an operation type (e.g., injection or sequence), an operation name, an operation time remaining and/or an operation time elapsed, an indication of a number of operations completed and/or a number of operations pending, a reservation assignee, or a combination thereof.

The instrument configuration portion may include information relating to the instruments 112 and/or IPCs 104 included in the scientific instrument group 118. For example, the instrument configuration portion 412 may include a name (e.g., a user-defined name) of each instrument 112 and/or IPC 104, a model of each instrument 112 and/or IPC 104, a representative or actual image of the device(s) 108 connected to each IPC 104 in the scientific instrument group 118, or a combination thereof.

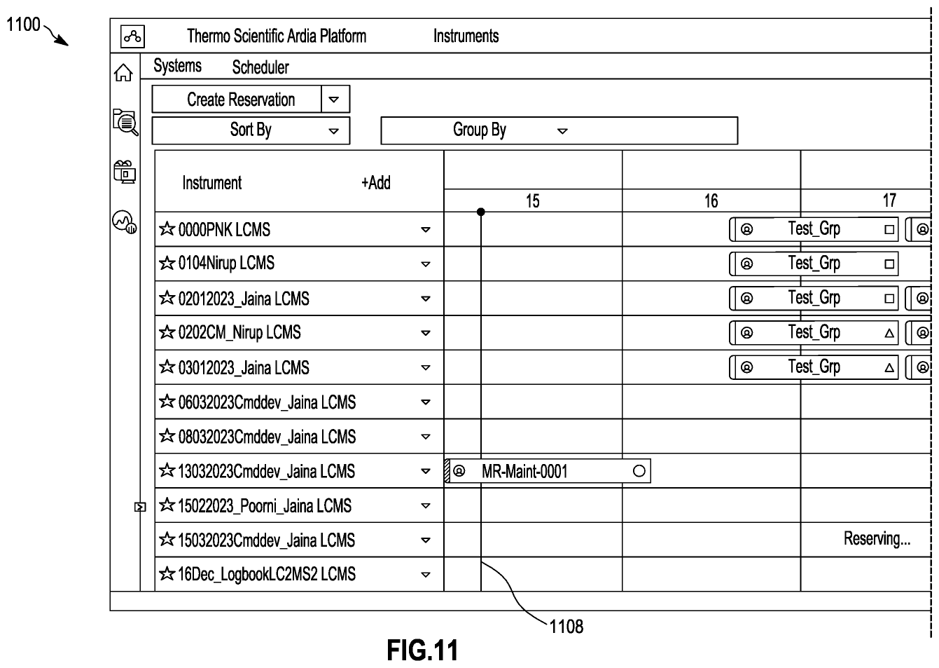

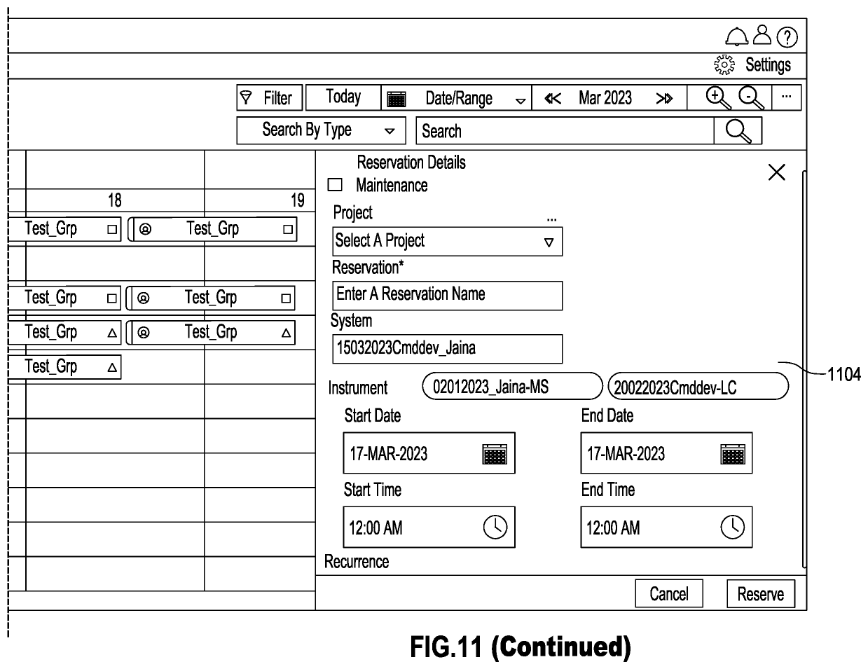

FIG. 4B illustrates a second example of a status card 400b that may be generated by the third logic 212 corresponding to a scientific instrument group 118 having an upcoming reservation, rather than an ongoing reservation. In the illustrated example, the reservation status portion 408 of the status card 400b includes an indication that the scientific instrument group 118 has an upcoming reservation, an indication of the reservation assignee, a start date of the reservation, and the start time of the reservation. Alternatively or in addition, the reservation status portion 408 may include a reservation name, a project name, a reservation end time, a reservation end date, and/or other reservation information associated with the upcoming reservation. The reservation status portion 408 may also include a link to a scheduler (e.g., a scheduler described in greater detail below with respect to FIGS. 11-18).

FIG. 4C illustrates a third example of a status card 40c that may be generated by the third logic 212 corresponding to a scientific instrument group 118. In the illustrated example, the reservation status portion 408 of the status card 400c includes an indication that the scientific instrument group 118 does not have any upcoming reservations. The reservation status portion 408 may include a prompt to schedule a reservation in a reservation scheduler.

FIG. 4D illustrates a fourth example of a status card 40d that may be generated by the third logic 212 corresponding to a scientific instrument group 118. In the illustrated example, the reservation status portion 408 of the status card 400c includes an indication that a network connection of the scientific instrument group 118 has been lost. In some instances, the reservation status portion 408 may therefore not include any reservation information associated with an upcoming or ongoing reservation of the scientific instrument group 118. The reservation status portion 408 may additionally include a prompt or instructions for resolving the connection of the scientific instrument group.

The third logic 212 provides a first user interface for displaying the status cards 400 generated for each of the plurality of scientific instrument groups 118. FIG. 5 illustrates an example of the first user interface, or asset view user interface 500. The third logic displays the asset view user interface 500 to a display of the user device 130, for example, using the application 336.

The asset view user interface 500 includes a status card 400 for each of the plurality of scientific instrument groups 118. In some instances, the asset view user interface 500 includes a status cards generated for each scientific instrument group 118, individual IPCs 104, individual instruments 112, and/or individual devices 108. The asset view user interface 500 enables a user to see an overview of the status of the lab (e.g., of the devices operating in the lab). As illustrated in FIG. 5, pinned status cards (as indicated by, for example, the pinned group indicator 414 illustrated in FIGS. 4A-4D) appear at the top of the asset view user interface 500. In some instances, in response to a user selecting and moving a status card 400 (e.g., by clicking and dragging a status card 400 to a different location in the asset view user interface 500), the third logic 212 move and reorder status cards 400 in the asset view user interface 500.

In some instances, the asset view user interface 500 selectively displays status cards 400 based on a setup status of the scientific instrument group 118 corresponding to each status card 400. For example, as illustrated in FIG. 5, the asset view user interface 500 may include a setup status indicator 504 for indicating whether the asset view user interface 500 is actively displaying status cards corresponding to active scientific instrument groups 118, disconnected scientific instrument groups 118 (e.g., disconnected from the network 120 or otherwise rendered inactive), or scientific instrument groups 118 waiting for setup (e.g., awaiting user configuration or setup in the server-based platform 300).

The asset view user interface 500 may also include a selectable filter option 508 for filtering the status cards 400 displayed in the asset view user interface 500 (see, e.g., FIG. 5). For example, in response to receiving a user selection of the filter option 508, the asset view user interface 500 (or a separate user interface generated, for example, by the third logic 212) may display one or more selectable characteristics. The selectable characteristics may include, for example, connection status (e.g., connected or lost connection), reservation status (e.g., ongoing reservation, upcoming reservation, no reservation), reservation assignee, scientific instrument group configuration, scientific instrument group name, pinned group indicator status, instrument type, operational status, assignee, owner, support ticket status, and the like. Accordingly, the third logic 212 can restrict the status cards 400 displayed in the asset view user interface to include only those chards having characteristics matching the selected filter characteristics.

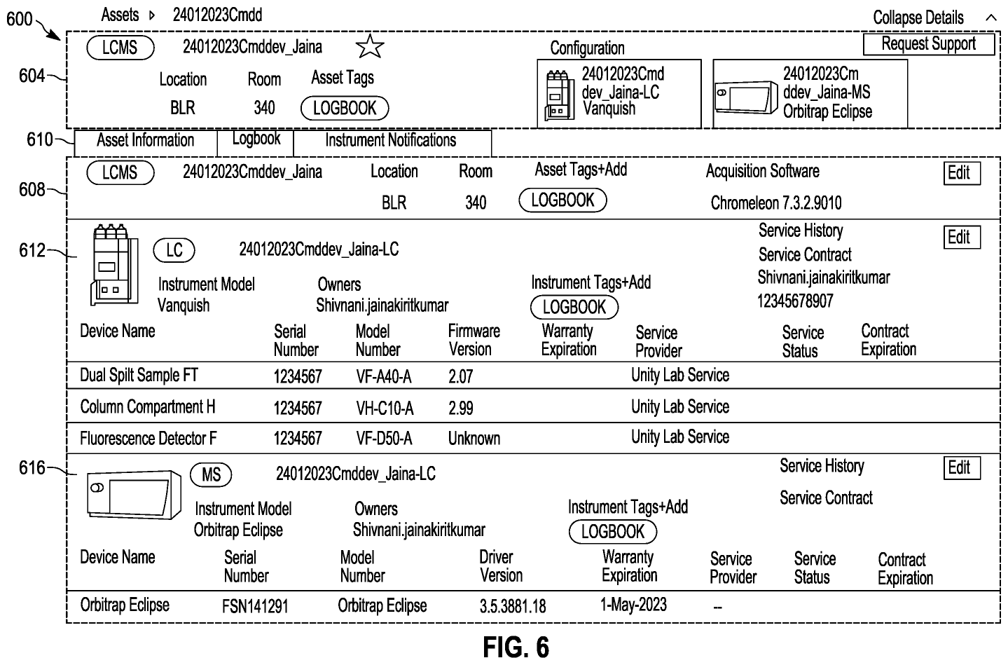

The fourth logic 216 may be configured to provide a second user interface in response to user selection, in the asset view user interface 500, of a status card 400 associated with a particular scientific instrument group 118. FIG. 6 illustrates an example of the second user interface, or system profile user interface 600, displaying additional asset information relating to the scientific instrument group 118 associated with the status card 400 selected in the asset view user interface 500. The system profile user interface 600 may include a system overview portion 604 and a system details portion 608. The system overview portion 604 displays, for example, a first subset of the asset information such as, for example, the instrument name, the group configuration indicator, a lab and/or location associated with the scientific instrument group 118, an identifier of instruments 112 included in the scientific instrument group 118, and/or the like. The system overview portion 604 may also include a selectable support option, wherein, in response to receiving a user selection of the support option, the server-based platform 300 may be configured to initiate support (e.g., for maintenance, troubleshooting, or the like) for one or more instruments 112 included in the scientific instrument group 118. The support may be provided through access to electronic user or maintenance guides for an instrument, a form for requesting maintenance for an instrument, a form for ordering replacement components for the instrument, or the like.

The system details portion 608 may include selectable options or tabs 610 for toggling between different views displayed in the system details portion 608. For example, a first view, or asset information view, illustrated in FIG. 6, displays a second subset of asset information associated with the scientific instrument group 118, such as, for example, the device details for each device 108 included in the scientific instrument group 118. The device details may be organized according to the scientific instrument 112 associated with each device 108. For example, a first scientific instrument 112 included in the scientific instrument group 118 may include three devices 108, and a second scientific instrument 112 included in the scientific instrument group 118 may include one device 108. Accordingly, a first subregion 612 of the asset information view may include an overview of the first scientific instrument 112 and device details associated with each of the corresponding devices 108, and a second subregion 616 may include an overview of the second scientific instrument 112 and device details associated with the corresponding device 108. The asset information view may additionally display the first subset of asset information.

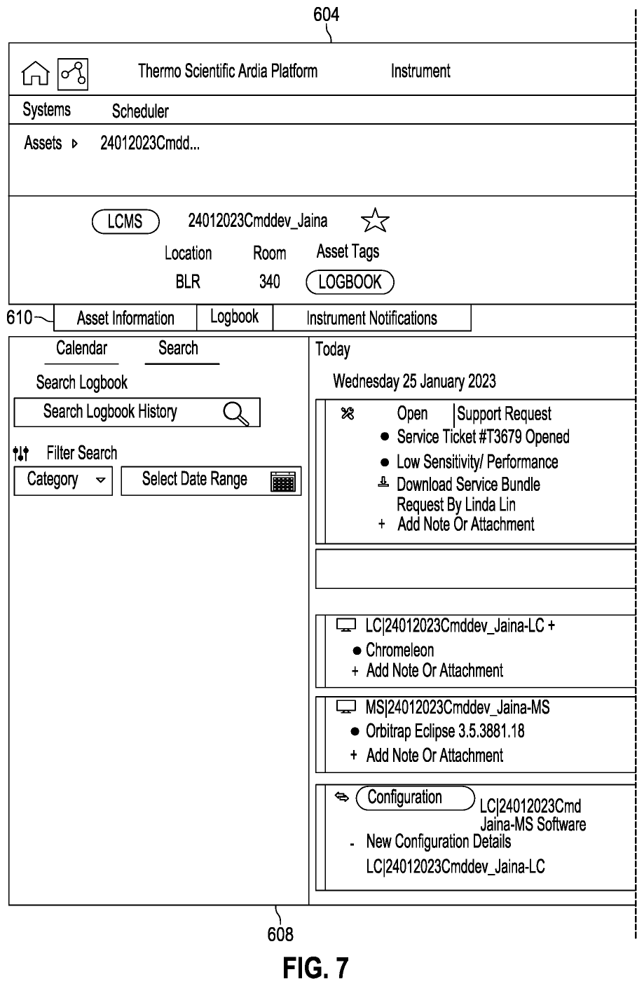

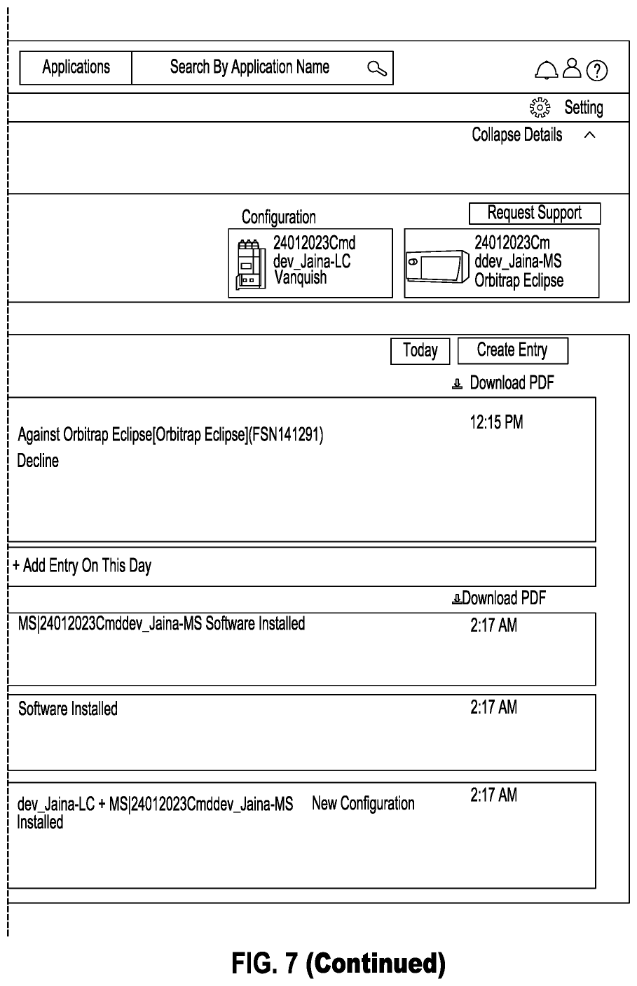

As illustrated in FIG. 7, a second view, or logbook view, may be displayed in the system details portion 608 of the system profile user interface 600. The logbook view displays a set of log entries associated with the scientific instrument group 118. The logbook view enables a user to view usage history, maintenance history, configuration history, and software history associated with the scientific instrument group 118 as a whole, instruments 112 included in the scientific instrument group 118, and/or specific device(s) 108 included in each instrument 112. Each log entry may include, for example, a date associated with the log entry, a category associated with the log entry (e.g., support request, software update/installation, configuration update, data acquisition operation, etc.), entry details associated with the log entry, or a combination thereof. For example, as illustrated in FIG. 7, a log entry associated with a support request may include an indicator of the status of the support request (e.g., open or closed), a ticket number associated with the support request, a description of the support request, a user associated with the support request, or the like. Each log entry may also optionally include a note or attachment added to the log entry by a user.

The logbook view may also display a search bar and/or filters for filtering the log entries displayed in the logbook view. For example, via the search bar and/or filters, the fourth logic 216 receives user-selections or inputs and applies the user-selections or input to search for or filter the entries for an instrument or device associated with a logbook entry, a category associated with a logbook entry, one or more keywords associated with a logbook entry, a date associated with a logbook entry, or the like. The logbook view additionally includes selectable option for creating a new logbook entry. In some instances, the fourth logic 216 only allows users with sufficient privileges to open new logbook entries.

A third view, or instrument notification view, may be displayed in the system details portion 608 of the system profile user interface 600. The instrument notification view may display notifications associated the scientific instrument group 118, instruments 112 included in the scientific instrument group 118, and/or specific device(s) 108 included in each instrument 112. The notifications may be configurable such that a user may select (via the instrument notification view) which notifications to receive. In addition to being displayed on the instrument notification view, the scientific instrument support module 200 may provide the notifications to one or more user devices (e.g., based on the configuration of the notification). The notifications may include a status update regarding an experiment or other operation being performed by the scientific instrument group 118, an indication that corrective maintenance is required for one or more devices 108 included in the scientific instrument group 118, an indication that preventative maintenance is required for one or more devices 108 included in the scientific instrument group 118, an indication that a configuration of the scientific instrument group 118 has change, an indication that maintenance or support has been completed, a reminder related to the start of an upcoming reservation for the scientific instrument group 118, a reminder related to an upcoming completion of an ongoing reservation for the scientific instrument group 118, or the like.

In some instances, the fourth logic 216 automatically creates logbook entries for devices 108, instruments 112, and/or scientific instrument groups 118 that are connected to the server-based platform 300 over the network 120 (e.g., using the instrument listener service 304). Automatic logbook entries may include, for example, recording operations, maintenance, instrument calibration, instrument configuration changes, device configuration changes, laboratory consumables, and the like.

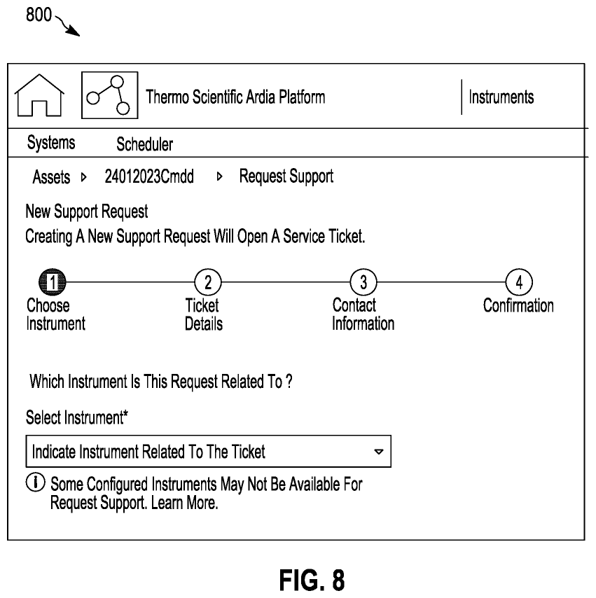

The fifth logic 220 may be configured to provide a support user interface, for example the support user interface 800 illustrated in FIG. 8, for generating a support ticket associated with a particular scientific instrument 112 included in the scientific instrument group 118. The fifth logic 220 may provide the support user interface 800 in response to, for example, receiving a user selection of a request support option in the system profile user interface 600. However, the fifth logic 220 may provide the support user interface 800 in response to other inputs or triggers. The support user interface 800 may include a selectable list of scientific instruments 112 and/or devices 108 included in the scientific instrument group 118. In some instances, only a subset of the scientific instruments 112 and/or devices 108 include in the scientific instrument group 118 are included in the list. The fifth logic 220 may determine a set of scientific instruments 112 and/or devices 108 included in the scientific instrument group 118 that may be included in the list for a support request.

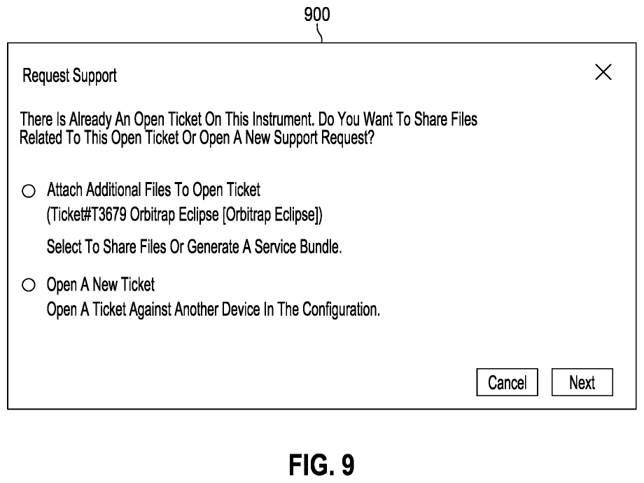

Referring now to FIG. 9, in response to receiving, through the support user interface 800, a user selection of an instrument 112 or device 108, the fifth logic 220 may determine that a support ticket is already open for that instrument 112 or device 108 and display an open ticket window 900 in the support user interface 800. The open ticket window 900 may provide an indication (message) that a ticket is already open for the selected instrument 112 or device 108. In some instances, the open ticket window 900 includes a ticket number associated with the open ticket and an instrument identifier or deice identifier associated with the instrument 112 or device 108. The open ticket window 900 may display a list of actions (e.g., with each list item corresponding to a selector, such as a radio button) and may initiate a listed action in response to user input select the action for the selected instrument 112 or device 108. For example, the list of actions may include attaching additional files to the open ticket, where the additional files are associated with the open support request for the selected instrument 112 or device 108. The list of actions may also include opening a new support ticket for the selected instrument 112 or device 108, or for a different instrument 101 or device 108 included in the scientific instrument group 118.

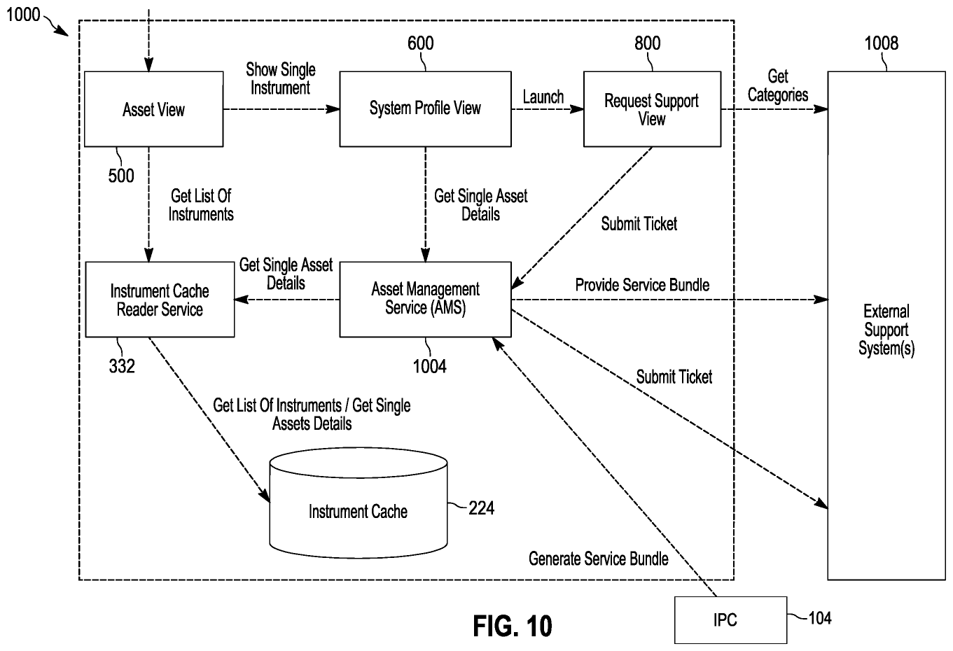

FIG. 10 illustrates a support workflow 1000 for opening a support ticket for a scientific instrument 112 or device 108. For example, the instrument cache reader service 332 of the server-based platform 300 may retrieve asset information including instrument information and device details from the cache 324. Information retrieved by the instrument cache reader service 332 is used (for example, by the third logic 212) to provide the asset view user interface 500 (which may also be referred to as a “systems” user interface). As described above, in response to selection of a status card corresponding to a scientific instrument group, the fourth logic 216 provides the system profile user interface 600 for displaying additional asset information associated with the selected scientific instrument group 118. An assets management service 1004 may retrieve the asset information associated with the selected scientific instrument group 118 from the instrument cache reader service 332 and provide the asset information to the system profile user interface 600.

Using, for example, the assets management service 1004, the fifth logic 220 generates the support ticket requested by the user. The assets management service 1004 retrieves instrument data (e.g., asset information) associated with the instrument 112 or device 108 for which the support ticket is opened using and provides a service bundle generated by an IPC 104 associated with the instrument. Including information relating to the instrument 112 from the instrument cache 324 in the service bundle may allow for more efficient and accurate diagnosis and maintenance of a malfunctioning instrument or device, as opposed to a support ticket that only includes information provided by a user. The service bundle and the support ticket may then be output from the assets management service 1004 to an external support system 1008 for analysis. In some instances, the fifth logic 220 may also provide one or more additional files (e.g., files associated with the support ticket and attached by the user) to the external support system 1008 for analysis.

The sixth logic 224 may be configured to provide a scheduler user interface, such as scheduler user interface 1100 illustrated in FIG. 11. The scheduler user interface 1100 includes an aggregated reservation schedule of each of the plurality of scientific instrument groups 118 and/or scientific instruments 112 in separate regions of the scheduler user interface 1100. Scientific instrument groups 118 and/or instruments 112 having reservation schedules included in the scheduler user interface 1100 may be scientific instrument groups 118 and/or instruments 112 with or without network connectivity.

Each region of the aggregated schedule represents a plurality of time slots where each of the plurality of time slots is marked as an unreserved time slot or a reserved time slot. Time slots included in the reservation schedule for each scientific instrument group 118 are aligned such that time slots representing the same time in each reservation schedule are aligned horizontally. It should be understood that FIG. 11 illustrates one example orientation of the reservation schedules and other orientations and configurations are possible, including, for example, a vertically-stacked orientation.

Each region associated with a scientific instrument group 118 may include a drop down menu and the sixth logic 224 may be configured to, in response to receiving a user selection of the drop menu, display (e.g., within the scheduler user interface 1100 or a separate user interface or pop-up) each of the scientific instruments 112 included in the scientific instrument group 118 and, in some instances, an aggregated reservation schedule for each of the scientific instruments 112 included in the respective scientific instrument group 118.

Each reserved time slot displayed in the scheduler user interface 1100 may include a reservation name and/or an indication of reservation type. A reservation type may include a standard reservation (e.g., a reservation to perform an experiment or other operation using a scientific instrument group 118), a maintenance reservation to perform maintenance on scientific instrument group 118, a partial reservation (e.g., a reservation on only a subset of instrument 112 included in a scientific instrument group 118), or another category of reservation. In some instances, the reservation types are user defined categories, and a user with sufficient privileges may add or remove categories. In some instances, one or more reserved time slots also include a project icon (e.g., a shape of a particular color) representative of a project associated with the respective reservation. For example, a purple square may represent a first project and a pink triangle may represent a second project. However, other types of icon or indicators may be used to represent particular projects.

The scheduler user interface 1100 may include an indication of the current date and time, such as for example, a vertical line 1108 intersecting each of the reservation schedules at a location corresponding to the current date and time. The scheduler user interface 1100 may include a selectable list for sorting the reservation schedules corresponding to each of the plurality of scientific instrument groups 118. For example, in response to user selections, the sixth logic 224 may sort each of the schedules chronologically by reservation start time, alphabetically by scientific instrument group name, group configuration, reservation assignee, reservation type or the like. The scheduler user interface 1100 may also include a selectable list (e.g., a drop down menu) for grouping the reservations by, for example, project, assignee (e.g., at least one assignee), group configuration, reservation type, or the like. The scheduler user interface may additionally include a selectable list (e.g., drop down menu) to filter the reservation schedules by, for example, pinned scientific instrument groups, project, assignee, group configuration, an available or reserved status, reservation type, or the like. In some instances, the scheduler user interface 1100 also includes a search bar for filtering the reservation schedules using one or more keywords.

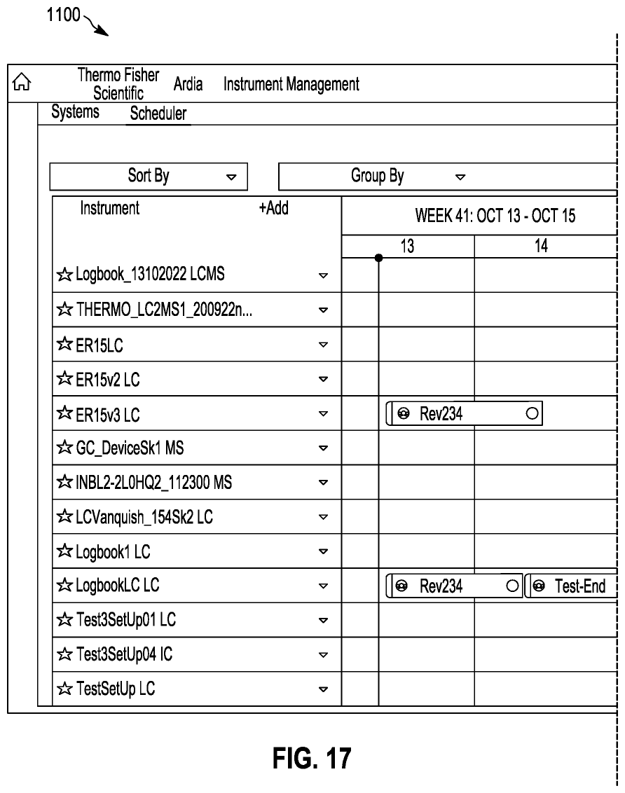

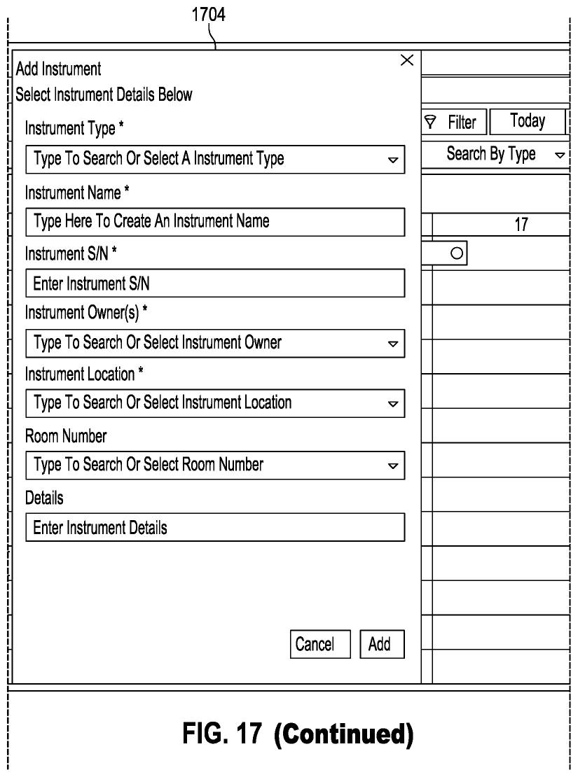

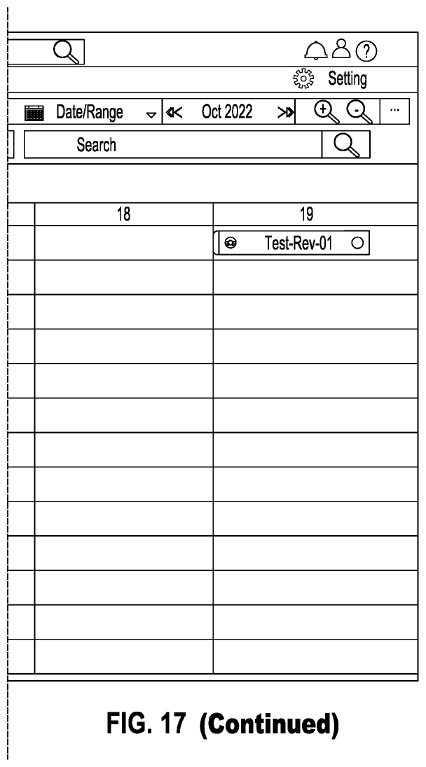

The scheduler user interface 1100 may also include one or more selectable options for showing an upcoming range of dates (e.g., an upcoming week, an upcoming month, etc.) or a previous range of dates (e.g., a previous week, a previous month, etc.). In response to user selection of an upcoming range of dates or a previous range of dates, the sixth logic 224 displays, in the scheduler user interface 1100, the aggregated reservation schedule for the corresponding one of the upcoming range of dates or the previous range of days. In some instances, the scheduler user interface 1100 includes a selectable calendar, and, in response to user selection of a date range using the selectable calendar, the sixth logic 2024 displays, in the scheduler user interface 1100, the aggregated reservation schedule for the range of dates selected using the selectable calendar. In some instances, the scheduler user interface 1100 includes a selectable option to zoom in or zoom out the aggregated schedule. For example, when the scheduler user interface 1100 displays a first range of dates, in response to user selection of an option to zoom in the aggregated schedule, the sixth logic 224 displays, in the scheduler user interface 1100, the aggregated schedule corresponding to a second range of dates, where the second range of dates is smaller than the first range of dates. For example, the second range of dates is included in the first range of dates. Similarly, when the scheduler user interface 1100 displays a first range of dates, in response to user selection of an option to zoom out the aggregated schedule, the sixth logic 224 displays, in the scheduler user interface 1100, the aggregated schedule corresponding to a second range of dates, where the second range of dates is larger than the first range of dates. For example, the first range of dates is included in the second range of dates. The scheduler user interface 1100 may also include a selectable option to add an instrument 112 or scientific instrument group 118 to the aggregated schedule (described in greater detail below with respect to FIG. 17).

In some instances, in response receiving a user selection (e.g., a click, double-click, or press and hold) of an unreserved time slot for a particular scientific instrument group, the sixth logic 224 provides a reservation editor panel 1104 (e.g., within the scheduler user interface 1100 or separate) for creating a new reservation for the scientific instrument group 118 associated with the selected time slot. The reservation editor panel 1104 may include a set of fields corresponding to reservation information for the new reservation. The set of fields may include, for example, a selectable list of projects with which the reservation may be associated, a reservation name, indicators of the instruments included in the scientific instrument group 118, a start date of the reservation, an end date of the reservation, a start time of the reservation, an end time of the reservation, a recurrence of the reservation, a text description of the reservation, an assignee of the reservation, an initiator of the reservation (e.g., the user creating the reservation), a selectable option for indicating that the reservation is a maintenance reservation, a scientific instrument group name or “system name,” or a combination thereof. All or some of the fields may be editable by a user. For example, in some instances, the initiator field or the system name of the scientific instrument group may be locked by the sixth logic 224 such that a user cannot edit this information. In some instances, in response to receiving a user selection of, in the reservation panel, the indicator of a particular instrument included in the scientific instrument group, the sixth logic 224 creates a partial reservation (i.e., limits the reservation to one particular instrument).

In some instances, the sixth logic 224 provides a list of available assignees that a user may selected from for a reservation. In other instances, in addition to or as an alternative to the list of available assignees, the sixth logic 224 determines a suggested assignee for a reservation and provides the suggestion to the scheduler user interface 1100 (e.g., to the reservation editor panel 1104). For example, the sixth logic 224 may access a memory (e.g., in the database 124) storing assignee data associated with each assignee. The assignee data may include a role and a schedule for the assignee, the schedule including, for example, working hours, time off, available and unavailable blocks of time, or the like. Based on the assignee data and, in some instances, the inputs to one or more reservation fields in the reservation editor panel 1104, the sixth logic 224 may determine the suggested assignee. For example, the sixth logic 224 may determine an assignee based on the reservation start time and/or reservation end time and provide the suggestion to the scheduler user interface 1100. Alternatively or in addition, the sixth logic 224 may determine a suggested assignee based on the owner of the instrument associated with the reservation, permissions of the user configuring the reservation, user reservation status, or a combination thereof.

In some instances, the sixth logic 224 determines a suggested reservation start time and/or start date for a new reservation (for a scientific instrument group 118 or a particular instrument 112, a suggested reservation end time and/or end date (e.g., based on the reservation schedule associated with the scientific instrument group 118, another aspects of the reservation, or a combination thereof, such as, for example, based on other reservation fields completed by the user (e.g., the assignee), historical operation or reservations, or the like. The sixth logic 224 may provide the suggestion to the user, for example, by populating a corresponding field associated with the new reservation, or otherwise displaying the suggestion to the user.

In some instances, the sixth logic 224 provides a reservation type suggestion to the scheduler user interface 1100 (e.g., in the reservation editor panel 1104). For example, the sixth logic may predict a date at which maintenance will be required for a particular scientific instrument 112 based on, for example, usage history of the particular scientific instrument 112. In some instances, the sixth logic 224 generates a notification indicating the reservation type suggestion (e.g., the maintenance suggestion), and provides the notification to the display device 130.

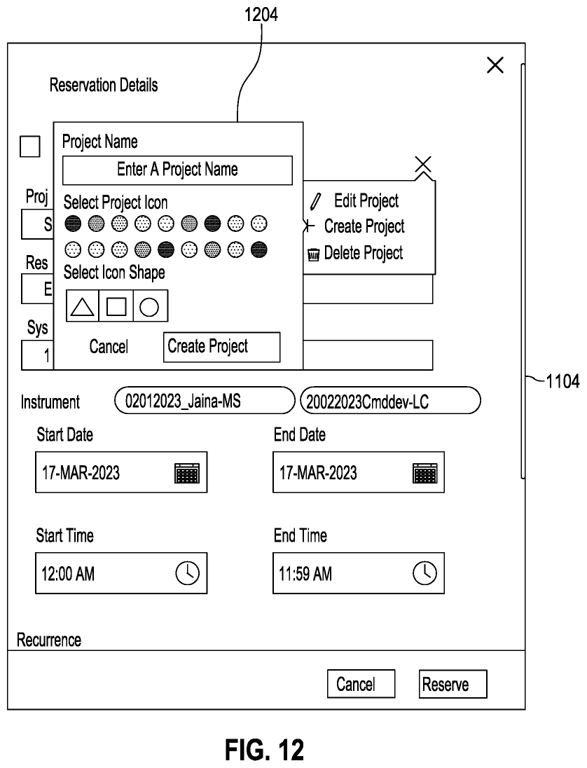

Referring now to FIG. 12, in some instances, the reservation editor panel 1104 includes a selectable option to edit a project included in the list of projects, to delete a project included in the list of projects, and/or create a new project. In some instances, only users with sufficient privileges (e.g., lab managers or project managers) may edit, delete, and/or create projects. In response to receiving, through the scheduler user interface 1100, a user selection to create or edit a project, the sixth logic 224 may display a project editor panel 1204 including a set of user-editable project fields. The set of project fields may include a project name, and a project icon (e.g., a shape and/or color associated with the project, or another customizable icon).

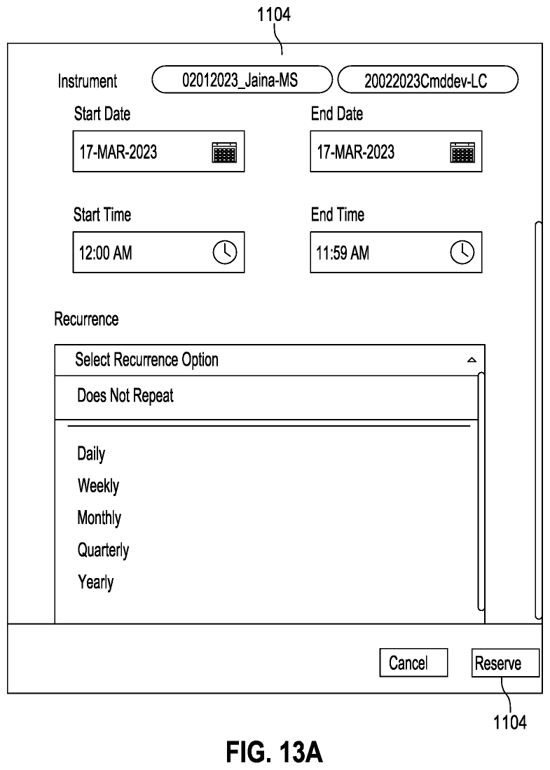

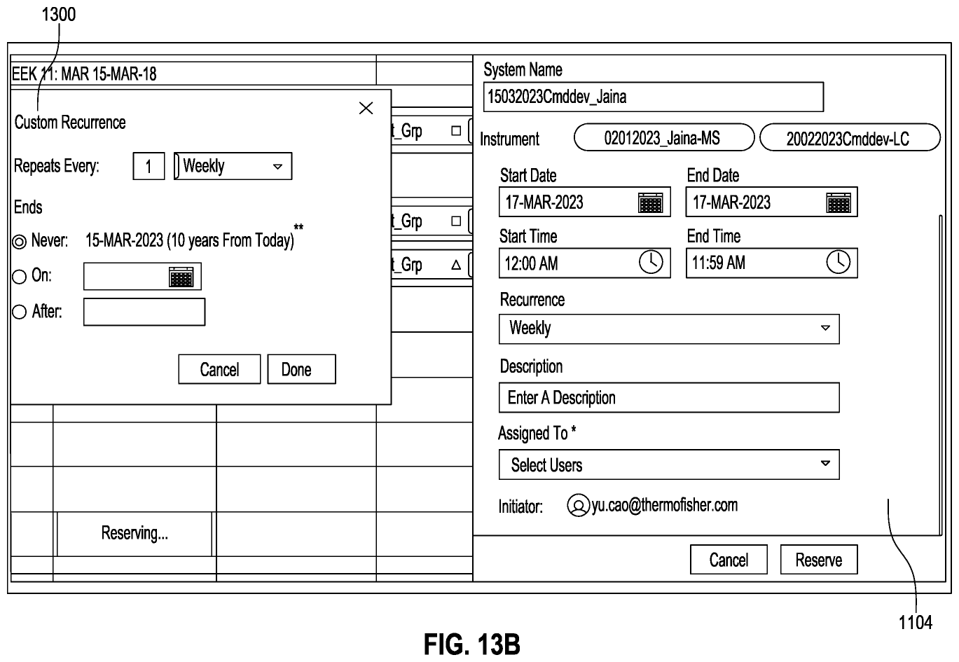

Referring now to FIG. 13A, the recurrence field may include a selectable drop down menu including a list of options for selecting a recurrence of the reservation of the scientific instrument group. For example, the list of recurrence options may include a daily recurrence, a weekly recurrence, a monthly recurrence, a quarterly recurrence, a yearly recurrence, a custom recurrence, and/or no recurrence. As illustrated in FIG. 13B, in some instances, the recurrence field includes a custom recurrence panel 1300. The custom recurrence panel 1300 may include a user-editable repetition count and repetition interval for setting the recurrence of the reservation. For example, when a repetition count is two and the repetition interval is a week, the sixth logic 224 generates the reservation having a recurrence every two weeks. The recurrence panel may also include a selectable option for setting an end date of the recurrence. For example, based on received user input, the sixth logic 224 may set the recurrence for a reservation to never end, to end on a selected date, or to end after a selected date.

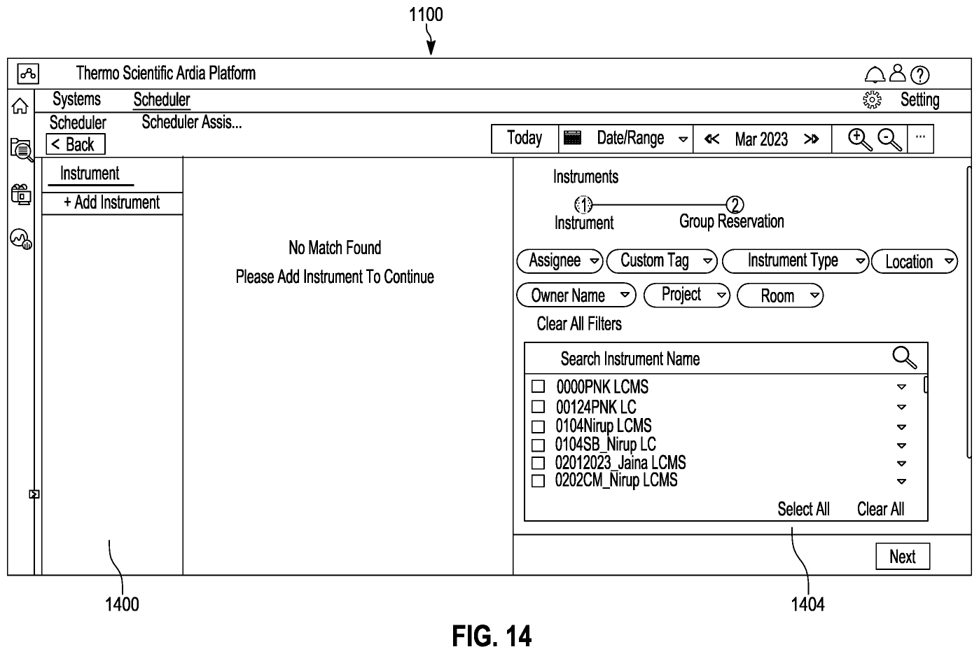

Referring again to FIG. 11, in some instances, a user may create a new reservation by selecting a new reservation or “create reservation” option. In response to receiving a user selection of the new reservation option, the sixth logic 224 may display a new reservation view 1400 within a portion of the scheduler user interface 1100 or separate, such as, for example, the new reservation view 1400 illustrated in FIG. 14. The new reservation view 1400 may include a selectable option to add at least one instrument 112 to the reservation. In response to receiving a user selection to add an instrument 112 to the reservation, the sixth logic 224 may display an instrument panel 1404 in the new reservation view 1400. The instrument panel 1404 may include a selectable list of instruments and/or scientific instrument groups that may be added to a reservation. For example, the instrument panel 1404 may enable a user to create a reservation for multiple instruments 112 or multiple scientific instrument groups 118. The instrument panel 1404 may also include a set of filters for filtering the list of instruments and/or scientific instrument groups by, for example, assignee, instrument type, location, owner name, room number, custom tags associated with the instrument or scientific instrument group, of the like.

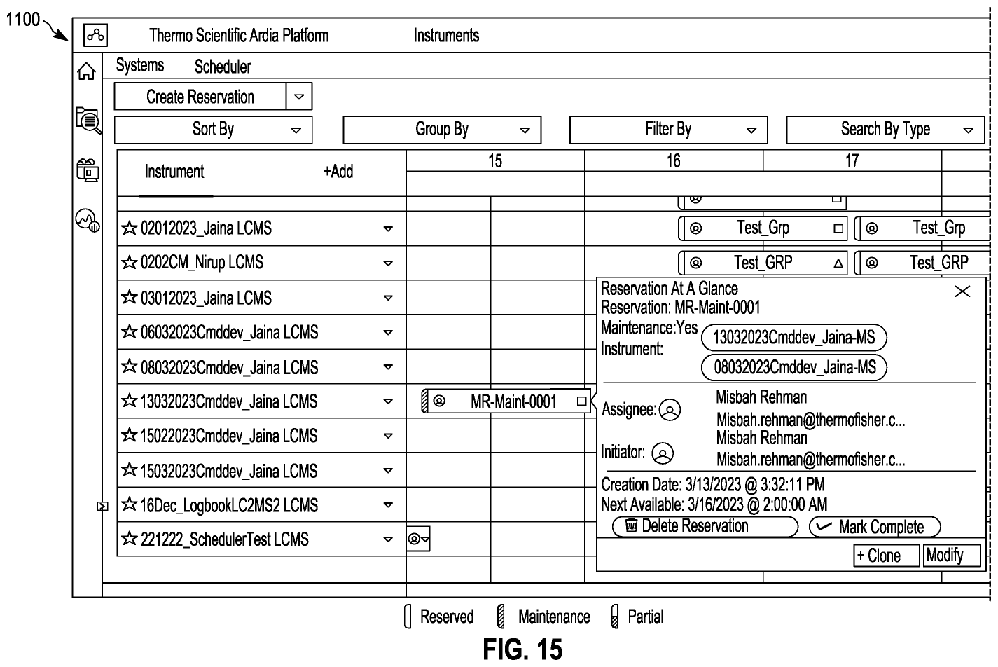

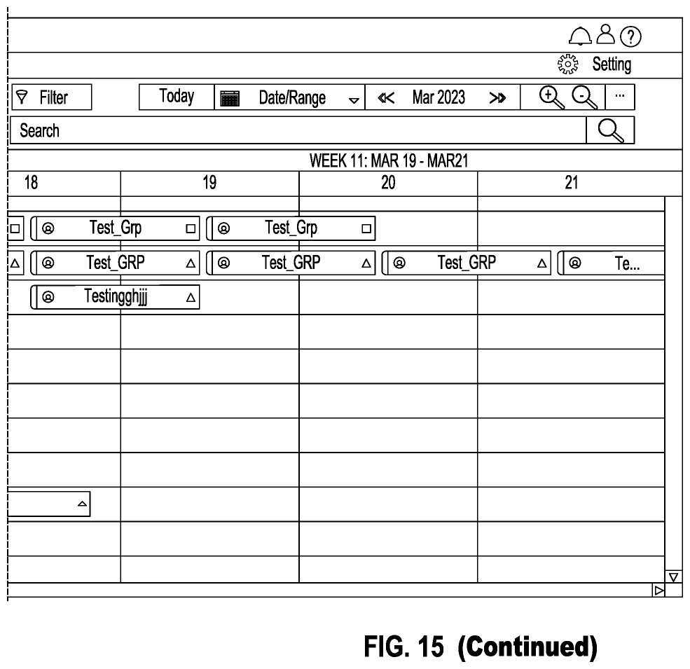

Referring now to FIG. 15, in response to receiving a user selection of a reserved time slot within a schedule displayed in the scheduler use interface 1100, the sixth logic 224 may display a reservation details panel 1504 associated with the selected reservation. The reservation details panel 1504 may display some or all of the fields associated with the reservation. For example, the reservation details panel 1504 may display a reservation name, a maintenance reservation indication, a set of instruments 112, an assignee, an initiator, a reservation creation date, and an upcoming availability of the scientific instrument group 118 associated with the selected reservation. In some instances, the reservation details panel 1504 includes a selectable option to mark the selected reservation complete when the selected reservation is an ongoing reservation. In some instances, the reservation details panel 1504 includes a selectable option to delete the selected reservation. The option to delete the reservation may be disabled when the reservation is a past reservation, an ongoing reservation, and/or when the user does not have sufficient privileges to modify or delete the selected reservation. For example, the sixth logic 224 may lock the reservation information associated with a past reservation.

Also, in some instances, the reservation details panel 1504 includes a selectable option to clone the selected reservation. Cloning a selected reservation may include, using the sixth logic 224, creating a new reservation for which one or more of the reservation fields for the new or “cloned” reservation are the same as those of the selected reservation. For example, a clone of a selected reservation may include the same instruments 112, assignee, project, reservation name, maintenance indicator, or a combination thereof. The cloned reservation may also include the same start time and/or as the selected reservation, but a different start date and/or end date. However, in some instances, the cloned reservation may include both a different start time and a different start date. It should be understood that some details for a reservation may be mandatory and others may be optional, and the system 100 may be configured prevent a user from completing or confirming a reservation unless fields or details flagged as being mandatory are completed.

In some instances, the reservation details panel 1504 may include a selectable option to modify the selected reservation. In response to receiving a user selection to modify the selected reservation, the sixth logic 224 may display the reservation editor panel 1104 for enabling a user (e.g., a user with sufficient privileges) to edit one or more reservation fields of the selected reservation.

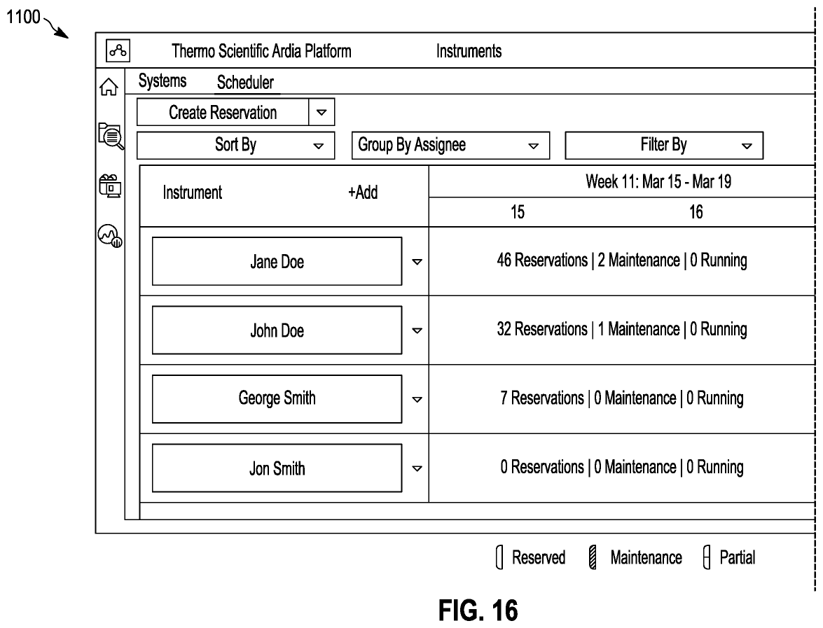

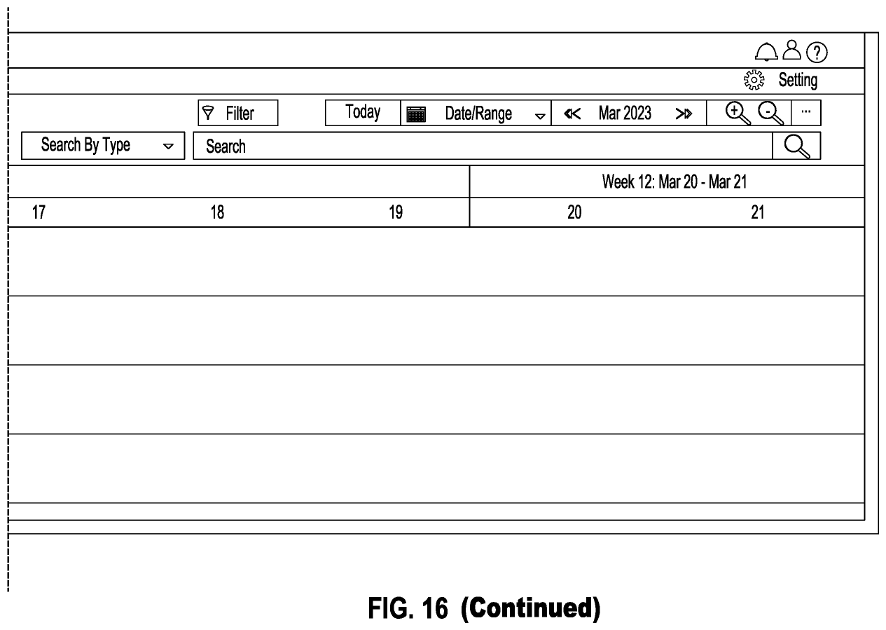

As described above with reference to FIG. 11, the scheduler user interface 1100 may include a drop down menu for grouping the reservations by, for example, project, assignee (e.g., at least one assignee), group configuration, reservation type, or the like. FIG. 16 illustrates an example of the scheduler user interface 1100 with the reservations grouped by assignee. When the reservations are grouped by assignee, the scheduler user interface 1100 may display an aggregated reservation schedule of each of assignees associated with the support system 100 in separate regions of the first user interface. Each region represents a time range in a calendar (a five day range of dates, a seven day range of dates, a monthlong range of dates, a daylong range of times, etc.) and includes a summary of the reservations associated with a respective assignee. For example, as illustrated in FIG. 16, a region associated with the assignee Jane Doe indicates that Jane Doe has a total of 46 reservations of scientific instrument groups, that two reservations are maintenance reservations, and that none of the reservations are currently ongoing, or “running.” In some instances, the summary of reservations is a summary of the reservations for only the displayed range of dates (e.g., March 15 through March 21) for the respective assignee. However, in some instances, the summary of reservations is a summary of all upcoming reservations for the respective assignee. Each region associated with an assignee may include a drop down menu that, in response to receiving a user selection of the drop down menu, displays an aggregated reservation schedule of each of the reservations associated with the respective assignee (e.g., including time slots substantially similar to those illustrated with respect to FIG. 11). FIG. 16 illustrates one example where reservations are grouped by assignee. As described above, reservations may also be grouped or filtered based on other characteristics, such as, for example, instrument settings, project, sample type, user, or the like.

As described above with reference to FIG. 11, the scheduler user interface 1100 may include a selectable option to add an instrument 112 or scientific instrument group 118 to the aggregated schedule. FIG. 17 illustrates an example instrument editor panel 1704 that the sixth logic 224 may display in response to receiving a user selection of the option to add an instrument 112. The instrument editor panel 1704 may include a plurality of editable new instrument fields associated with the instrument 112 to be added to the aggregated schedules. For example, the new instrument fields may include an instrument type field, an instrument name field, an instrument serial number field, an instrument owner field, an instrument location field, an instrument room number field, an instrument details field, or a combination thereof. Some or all of the fields may be, for example, editable text fields. However, as illustrated in FIG. 17, one or more of the new instrument fields may be, for example, drop-down menus populated with stored data associated with each field (e.g., a stored set of lab locations, a stored set of room numbers, a stored set of instrument types, a stored set of instrument owners, etc.).

A first subset of the new instrument fields may be required fields, while a second subset of the new instrument fields may be optional fields. For example, the sixth logic 224 may disable an option to add the new instrument to the aggregated schedule until all of the required new instrument fields are completed (e.g., populated or populated with a valid input). The required new instrument fields may include, for example, the instrument type, the instrument name, the instrument serial number, the instrument owner, or a combination thereof.

In some instances, the sixth logic 224 enables a user to modify one or more fields of an instrument already included in the aggregated reservation schedule using the instrument editor panel 1704. For example, in response to receiving a user selection, within the scheduler user interface 1100, of an option to edit instrument fields associated with a selected instrument 112, the sixth logic 224 may display the instrument editor panel 1704. In such instances, the sixth logic 224 may populate the fields of the instrument editor panel 1704 with stored instrument data associated with the selected scientific instrument 112.

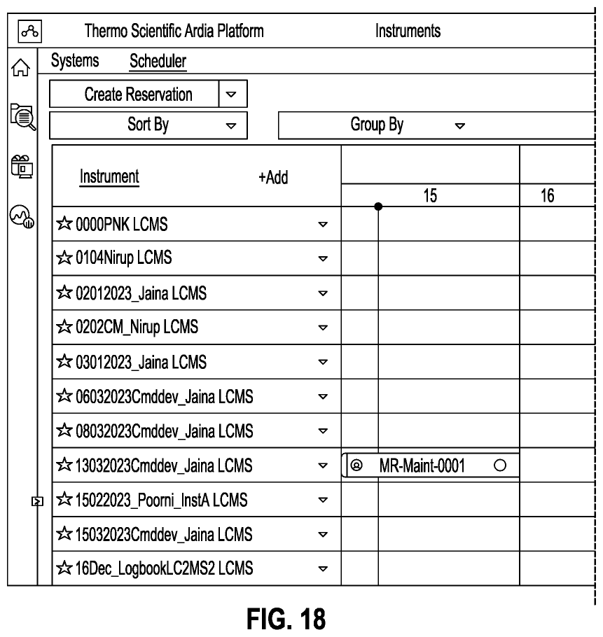

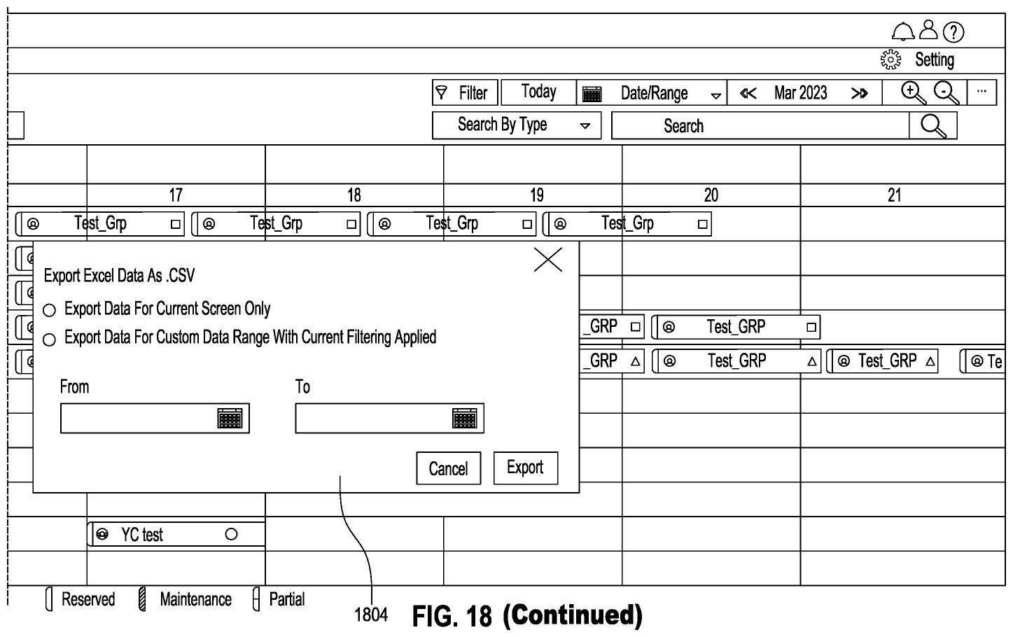

Referring now to FIG. 18, the scheduler user interface 1100 may include a selectable option to export aggregated reservation schedule data to a file, such as a CSV file, an XLSX file, or the like. In response to receiving a user selection of the option to export the aggregated reservation schedule, the sixth logic 224 may display a data export panel 1804 (e.g., within the scheduler user interface 1100 or separate from the scheduler user interface 1100). The data export panel 1804 may include at least one selectable option to export the aggregated schedule of reservations associated with a date range currently displayed in the scheduler user interface or to export the aggregated schedule of reservations associated with a custom data range. For example, the data export panel 1804 may include an editable field for entering a start date and an end date for data export. In response to receiving a user selection of an option to export the data, the sixth logic 224 may generate a file populated with the reservation schedule data for the selected date range.

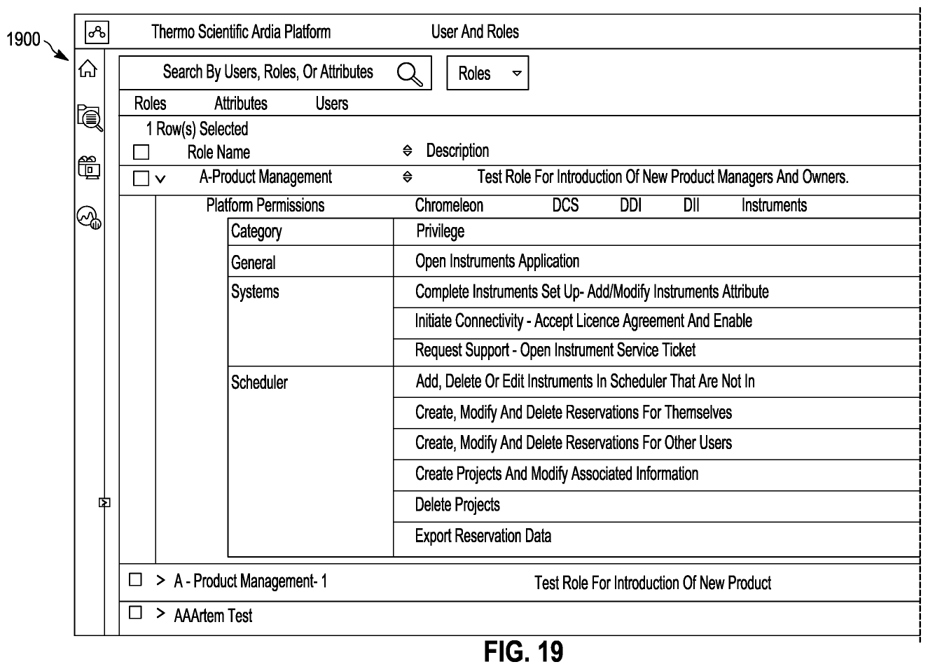

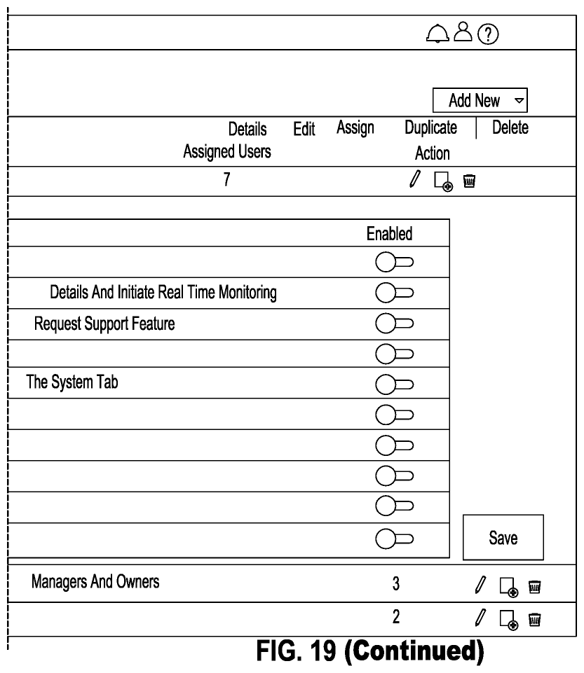

The seventh logic 228 may be configured to provide a user settings user interface, such as user settings user interface 1900 illustrated in FIG. 19. The user settings user interface 1900 may display a list of user types or roles and a set of permissions, or privileges that may be enabled or disabled for each role. User roles may include, for example, lab manager, project manager, scientist, technician, owner, product manager, or the like. In some instances, user privileges for particular roles may only be modified by a user with credentials to modify user role privileges. Each user privilege included in the set of user privileges may be toggled between an enabled state, enabling the user privilege for that role, and a disabled state, disabling the user privilege for that role.

In some instances, for each role, the set of permissions are arranged according to category, such as, for example, a general category (e.g., relating to the general system 100), a systems category (e.g., relating to instrument connectivity in the system 100), a scheduler category (e.g., relating to operations performed within the scheduler user interface 1100), or the like. Privileges included in the general category for a particular user role may include, for example, opening the application 336. Privileges included in the systems category for a particular user role may include, for example, completing instrument setup, initiating connectivity of an instrument 112 over the network 120, accepting license agreements associated with an instrument 112, enabling the request support feature for an instrument 112, opening a support ticket for an instrument 112, or the like. Privileges included in the scheduler category for a particular user role may include, for example, managing (e.g., adding, deleting, or editing) instruments in the scheduler (e.g., using the instrument editor panel 1704), managing reservations for themselves, managing reservations for another user, creating and modifying projects, deleting projects, exporting reservation data, or the like.

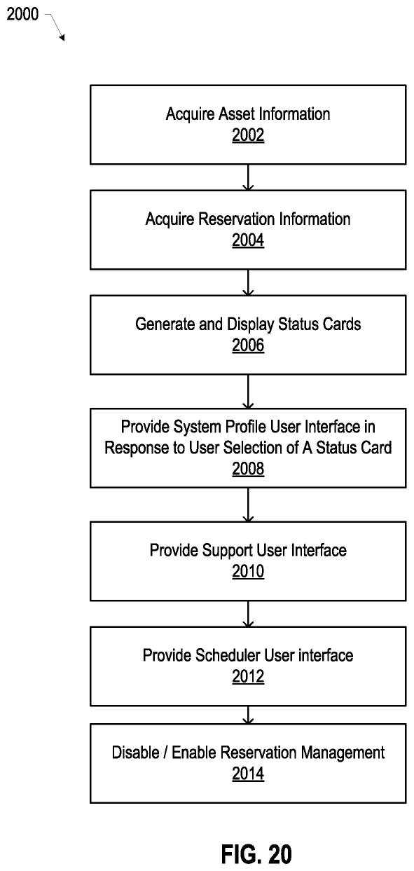

FIG. 20 is a flow diagram of a method 2000 of performing support operations, in accordance with various embodiments. Although the operations of the method 2000 may be illustrated with reference to particular embodiments disclosed herein (e.g., the scientific instrument support modules 200 discussed herein with reference to FIG. 2, the status cards 400 discussed herein with reference to FIGS. 4A-4D, the server-based platform discussed with reference to FIG. 3, the asset view user interface 500 discussed herein with reference to FIG. 5, the system profile user interface 600 discussed herein with reference to FIGS. 6 and 7, the support user interface 800 discussed herein with reference to FIGS. 8 and 9, the scheduler user interface discussed herein with reference to FIGS. 11-18, the settings user interface discussed herein with reference to FIG. 19, the GUI 2100 discussed herein with reference to FIG. 21, the computing devices 2200 discussed herein with reference to FIG. 22, and/or the scientific instrument support system 2300 discussed herein with reference to FIG. 23), the method 2000 may be used in any suitable setting to perform any suitable support operations. Operations are illustrated once each and in a particular order in FIG. 20, but the operations may be reordered and/or repeated as desired and appropriate (e.g., different operations performed may be performed in parallel, as suitable).

At 2002, first operations may be performed. For example, the first logic 204 of the support module 200 may perform the first operations of 2002. The first operations may include acquiring, for each of a plurality of scientific instrument groups (e.g., the scientific instrument groups 118 described above with respect to FIG. 1), asset information associated with the scientific instrument group, where the scientific instrument group including at least one scientific instrument (e.g., scientific instruments described above with respect to FIG. 1).

At 2004, second operations may be performed. For example, the second logic 208 of the support module 200 may perform the second operations of 2004. The second operations may include acquiring, for each of the plurality of scientific instrument groups, reservation information associated with the scientific instrument group.

At 2006, third operations may be performed. For example, the third logic 212 of the support module 200 may perform the operations of 2006. The third operations may include generating, for each of the plurality of scientific instrument groups, a status card (e.g., a status card 400 described above with respect to FIGS. 4A-4D) including status information associated with the scientific instrument group, wherein the status information is at least based on the asset information and the reservation information, and the third logic provides a first user interface (e.g., the asset view user interface 500 described above with reference to FIG. 5) for displaying the status cards. Responsive UI display technologies, such as, for example, virtual scrolling, pagination, and optimized data fetching per demand, dynamic subscription and unsubscription of data notification per user request, or a combination thereof, may be used in the first user interface (as well as other user interfaces provided via the support system). These technologies support both large enterprise scale of labs and small labs with optimized performance. For example, virtual scrolling and dynamic subscription and unsubscription allows only relevant (e.g., notifications representing changes in information) server-side notifications (e.g., data included in a provided mini plot) that are received to be shown or pushed (updated) to the current view (user interface), which may be provided via a browser application running on the user device 130. Accordingly, these technologies minimize network traffic and allow the support system 100 to monitor hundreds to thousands of instruments concurrently.

At 2008, fourth operations may be performed. For example, the fourth logic 216 of the support module 200 may perform the operations of 2008. The fourth operations may include providing, in response to receiving a user selection of a status card 400 associated with a particular scientific instrument group 118, a second user interface (e.g., the system profile user interface 600 described above with reference to FIGS. 6 and 7).

At 2010, fifth operations may be performed. For example, the fifth logic 220 of the support module 200 may perform the fifth operations of 2010. The fifth operations may include providing a third interface (e.g., the support user interface 800 described above with respect to FIGS. 8 and 9) for generating a support ticket associated with a particular scientific instrument 112 included in the scientific instrument group 118, the third user interface including a user-selectable list of scientific instruments 112 included in the scientific instrument group 118 of a support module 200.

At 2012, sixth operations may be performed. For example, the sixth logic 224 of the support module 200 may perform the sixth operations of 2012. The sixth operations may include providing a fourth user interface (e.g., the scheduler user interface 1100 described above with respect to FIGS. 11-18), the fourth user interface including a reservation schedule of each of the plurality of scientific instrument groups 118.

At 2014, seventh operations may be performed. For example, the seventh logic 228 of the support module 200 may perform the operations of 2014. The seventh operations may include selectively enabling and disabling modification of the reservation schedule according to user privilege.

The scientific instrument support methods disclosed herein may include interactions with a human user (e.g., via the user local computing device 230 discussed herein with reference to FIG. 23). These interactions may include providing information to the user (e.g., information regarding the operation of a scientific instrument such as the scientific instrument 2310 of FIG. 23, information regarding a sample being analyzed or other test or measurement performed by a scientific instrument, information retrieved from a local or remote database, or other information) or providing an option for a user to input commands or other information. In some embodiments, these interactions may be performed through a graphical user interface (GUI) that includes a visual display on a display device (e.g., the display device 2210 discussed herein with reference to FIG. 22) that provides outputs to the user and/or prompts the user to provide inputs (e.g., via one or more input devices, such as a keyboard, mouse, trackpad, or touchscreen, included in the other I/O devices 2212 discussed herein with reference to FIG. 22). The scientific instrument support systems disclosed herein may include any suitable GUIs for interaction with a user.

FIG. 21 depicts an example GUI 2100 that may be used in the performance of some or all of the support methods disclosed herein, in accordance with various embodiments. As noted above, the GUI 2100 may be provided on a display device (e.g., the display device 2210 discussed herein with reference to FIG. 22) of a computing device (e.g., the computing device 2200 discussed herein with reference to FIG. 22) of a scientific instrument support system (e.g., the scientific instrument support system 2300 discussed herein with reference to FIG. 23), and a user may interact with the GUI 2100 using any suitable input device (e.g., any of the input devices included in the other I/O devices 2212 discussed herein with reference to FIG. 22) and input technique (e.g., movement of a cursor, motion capture, facial recognition, gesture detection, voice recognition, actuation of buttons, etc.).

The GUI 2100 may include a data display region 2102, a data analysis region 2104, a scientific instrument management region 2106, and a settings region 2108. The particular number and arrangement of regions depicted in FIG. 21 is simply illustrative, and any number and arrangement of regions, including any desired features, may be included in a GUI 2100.

The data display region 2102 may display data generated by a scientific instrument (e.g., the scientific instrument 2310 discussed herein with reference to FIG. 23). For example, the data display region 2102 may display the aggregated reservation schedule of FIG. 11.

The data analysis region 2104 may display the results of data analysis (e.g., the results of analyzing the data illustrated in the data display region 2102 and/or other data). For example, the data analysis region 2104 may include the list of instruments 112 and/or scientific instrument groups 118 included in the aggregated schedule displayed in the scheduler user interface 1100 of FIG. 11. In some embodiments, the data display region 2102 and the data analysis region 2104 may be combined in the GUI 2100 (e.g., to include data output from a scientific instrument, and some analysis of the data, in a common graph or region).

The scientific instrument management region 2106 may include options that allow the user to manage a scientific instrument (e.g., the scientific instrument 2310 discussed herein with reference to FIG. 23). For example, the scientific instrument management region 2106 may include the reservation editor panel 1104 displayed in the scheduler user interface 1100 of FIG. 11.

The settings region 2108 may include options that allow the user to manage the features and functions of the GUI 2100 (and/or other GUIs) and/or perform common computing operations with respect to the data display region 2102 and data analysis region 2104 (e.g., saving data on a storage device, such as the storage device 2204 discussed herein with reference to FIG. 22, sending data to another user, labeling data, etc.). For example, the settings region 2108 may include the sorting option, the grouping option, the filtering option, and/or the search bar illustrated in the scheduler user interface 1100 of FIG. 11.

As noted above, the scientific instrument support module 200 may be implemented by one or more computing devices. FIG. 22 is a block diagram of a computing device 2200 that may perform some or all of the scientific instrument support methods disclosed herein, in accordance with various embodiments. In some embodiments, the scientific instrument support module 200 may be implemented by a single computing device 2200 or by multiple computing devices 2200. Further, as discussed below, a computing device 2200 (or multiple computing devices 2200) that implements the scientific instrument support module 200 may be part of one or more of the scientific instrument 2310, the user local computing device 2320, the service local computing device 2330, or the remote computing device 2340 of FIG. 23.

The computing device 2200 of FIG. 22 is illustrated as having a number of components, but any one or more of these components may be omitted or duplicated, as suitable for the application and setting. In some embodiments, some or all of the components included in the computing device 2200 may be attached to one or more motherboards and enclosed in a housing (e.g., including plastic, metal, and/or other materials). In some embodiments, some these components may be fabricated onto a single system-on-a-chip (SoC) (e.g., an SoC may include one or more processing devices 2202 and one or more storage devices 2204). Additionally, in various embodiments, the computing device 2200 may not include one or more of the components illustrated in FIG. 22, but may include interface circuitry (not shown) for coupling to the one or more components using any suitable interface (e.g., a Universal Serial Bus (USB) interface, a High-Definition Multimedia Interface (HDMI) interface, a Controller Area Network (CAN) interface, a Serial Peripheral Interface (SPI) interface, an Ethernet interface, a wireless interface, or any other appropriate interface). For example, the computing device 2200 may not include a display device 2210, but may include display device interface circuitry (e.g., a connector and driver circuitry) to which a display device 2210 may be coupled.

The computing device 2200 may include a processing device 2202 (e.g., one or more processing devices). As used herein, the term “processing device” may refer to any device or portion of a device that processes electronic data from registers and/or memory to transform that electronic data into other electronic data that may be stored in registers and/or memory. The processing device 2202 may include one or more digital signal processors (DSPs), application-specific integrated circuits (ASICs), central processing units (CPUs), graphics processing units (GPUs), cryptoprocessors (specialized processors that execute cryptographic algorithms within hardware), server processors, or any other suitable processing devices.

The computing device 2200 may include a storage device 2204 (e.g., one or more storage devices). The storage device 2204 may include one or more memory devices such as random access memory (RAM) (e.g., static RAM (SRAM) devices, magnetic RAM (MRAM) devices, dynamic RAM (DRAM) devices, resistive RAM (RRAM) devices, or conductive-bridging RAM (CBRAM) devices), hard drive-based memory devices, solid-state memory devices, networked drives, cloud drives, or any combination of memory devices. In some embodiments, the storage device 2204 may include memory that shares a die with a processing device 2202. In such an embodiment, the memory may be used as cache memory and may include embedded dynamic random access memory (eDRAM) or spin transfer torque magnetic random access memory (STT-MRAM), for example. In some embodiments, the storage device 2204 may include non-transitory computer readable media having instructions thereon that, when executed by one or more processing devices (e.g., the processing device 2202), cause the computing device 2200 to perform any appropriate ones of or portions of the methods disclosed herein.

The computing device 2200 may include an interface device 2206 (e.g., one or more interface devices 2206). The interface device 2206 may include one or more communication chips, connectors, and/or other hardware and software to govern communications between the computing device 2200 and other computing devices. For example, the interface device 2206 may include circuitry for managing wireless communications for the transfer of data to and from the computing device 2200. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not. Circuitry included in the interface device 2206 for managing wireless communications may implement any of a number of wireless standards or protocols, including but not limited to Institute for Electrical and Electronic Engineers (IEEE) standards including Wi-Fi (IEEE 82.11 family), IEEE 82.16 standards (e.g., IEEE 82.16-2005 Amendment), Long-Term Evolution (LTE) project along with any amendments, updates, and/or revisions (e.g., advanced LTE project, ultra mobile broadband (UMB) project (also referred to as “3GPP2”), etc.). In some embodiments, circuitry included in the interface device 2206 for managing wireless communications may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. In some embodiments, circuitry included in the interface device 2206 for managing wireless communications may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). In some embodiments, circuitry included in the interface device 2206 for managing wireless communications may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. In some embodiments, the interface device 2206 may include one or more antennas (e.g., one or more antenna arrays) to receipt and/or transmission of wireless communications.

In some embodiments, the interface device 2206 may include circuitry for managing wired communications, such as electrical, optical, or any other suitable communication protocols. For example, the interface device 2206 may include circuitry to support communications in accordance with Ethernet technologies. In some embodiments, the interface device 2206 may support both wireless and wired communication, and/or may support multiple wired communication protocols and/or multiple wireless communication protocols. For example, a first set of circuitry of the interface device 2206 may be dedicated to shorter-range wireless communications such as Wi-Fi or Bluetooth, and a second set of circuitry of the interface device 2206 may be dedicated to longer-range wireless communications such as global positioning system (GPS), EDGE, GPRS, CDMA, WiMAX, LTE, EV-DO, or others. In some embodiments, a first set of circuitry of the interface device 2206 may be dedicated to wireless communications, and a second set of circuitry of the interface device 2206 may be dedicated to wired communications.

The computing device 2200 may include battery/power circuitry 2208. The battery/power circuitry 2208 may include one or more energy storage devices (e.g., batteries or capacitors) and/or circuitry for coupling components of the computing device 2200 to an energy source separate from the computing device 2200 (e.g., AC line power).

The computing device 2200 may include a display device 2210 (e.g., multiple display devices). The display device 2210 may include any visual indicators, such as a heads-up display, a computer monitor, a projector, a touchscreen display, a liquid crystal display (LCD), a light-emitting diode display, or a flat panel display.

The computing device 2200 may include other input/output (I/O) devices 2212. The other I/O devices 2212 may include one or more audio output devices (e.g., speakers, headsets, earbuds, alarms, etc.), one or more audio input devices (e.g., microphones or microphone arrays), location devices (e.g., GPS devices in communication with a satellite-based system to receive a location of the computing device 2200, as known in the art), audio codecs, video codecs, printers, sensors (e.g., thermocouples or other temperature sensors, humidity sensors, pressure sensors, vibration sensors, accelerometers, gyroscopes, etc.), image capture devices such as cameras, keyboards, cursor control devices such as a mouse, a stylus, a trackball, or a touchpad, bar code readers, Quick Response (QR) code readers, or radio frequency identification (RFID) readers, for example.

The computing device 2200 may have any suitable form factor for its application and setting, such as a handheld or mobile computing device (e.g., a cell phone, a smart phone, a mobile internet device, a tablet computer, a laptop computer, a netbook computer, an ultrabook computer, a personal digital assistant (PDA), an ultra mobile personal computer, etc.), a desktop computing device, or a server computing device or other networked computing component.

One or more computing devices implementing any of the scientific instrument support modules or methods disclosed herein may be part of a scientific instrument support system. FIG. 23 is a block diagram of an example scientific instrument support system 2300 in which some or all of the scientific instrument support methods disclosed herein may be performed, in accordance with various embodiments. The scientific instrument support modules and methods disclosed herein (e.g., the scientific instrument support module 200 of FIG. 2 and the method 2000 of FIG. 20) may be implemented by one or more of the scientific instrument 2310, the user local computing device 2320, the service local computing device 2330, or the remote computing device 2340 of the scientific instrument support system 2300.

Any of the scientific instrument 2310, the user local computing device 2320, the service local computing device 2330, or the remote computing device 2340 may include any of the embodiments of the computing device 2200 discussed herein with reference to FIG. 22, and any of the scientific instrument 2310, the user local computing device 2320, the service local computing device 2330, or the remote computing device 2340 may take the form of any appropriate ones of the embodiments of the computing device 2200 discussed herein with reference to FIG. 22.

The scientific instrument 2310, the user local computing device 2320, the service local computing device 2330, or the remote computing device 2340 may each include a processing device 2302, a storage device 2304, and an interface device 2306. The processing device 2302 may take any suitable form, including the form of any of the processing devices 2202 discussed herein with reference to FIG. 22, and the processing devices 2302 included in different ones of the scientific instrument 2310, the user local computing device 2320, the service local computing device 2330, or the remote computing device 2340 may take the same form or different forms. The storage device 2304 may take any suitable form, including the form of any of the storage devices 2204 discussed herein with reference to FIG. 22, and the storage devices 2304 included in different ones of the scientific instrument 2310, the user local computing device 2320, the service local computing device 2330, or the remote computing device 2340 may take the same form or different forms. The interface device 2306 may take any suitable form, including the form of any of the interface devices 2206 discussed herein with reference to FIG. 22, and the interface devices 2306 included in different ones of the scientific instrument 2310, the user local computing device 2320, the service local computing device 2330, or the remote computing device 2340 may take the same form or different forms.

The scientific instrument 2310, the user local computing device 2320, the service local computing device 2330, and the remote computing device 2340 may be in communication with other elements of the scientific instrument support system 2300 via communication pathways 2308. The communication pathways 2308 may communicatively couple the interface devices 2306 of different ones of the elements of the scientific instrument support system 2300, as shown, and may be wired or wireless communication pathways (e.g., in accordance with any of the communication techniques discussed herein with reference to the interface devices 2206 of the computing device 2200 of FIG. 22). The particular scientific instrument support system 2300 depicted in FIG. 23 includes communication pathways between each pair of the scientific instrument 2310, the user local computing device 2320, the service local computing device 2330, and the remote computing device 2340, but this “fully connected” implementation is simply illustrative, and in various embodiments, various ones of the communication pathways 2308 may be absent. For example, in some embodiments, a service local computing device 2330 may not have a direct communication pathway 2308 between its interface device 2306 and the interface device 2306 of the scientific instrument 2310, but may instead communicate with the scientific instrument 2310 via the communication pathway 2308 between the service local computing device 2330 and the user local computing device 2320 and the communication pathway 2308 between the user local computing device 2320 and the scientific instrument 2310.

The scientific instrument 2310 may include any appropriate scientific instrument, such as a scientific instrument 112 described above with respect to FIG. 1.

The user local computing device 2320 may be a computing device (e.g., in accordance with any of the embodiments of the computing device 2200 discussed herein) that is local to a user of the scientific instrument 2310. In some embodiments, the user local computing device 2320 may also be local to the scientific instrument 2310, but this need not be the case; for example, a user local computing device 2320 that is in a user's home or office may be remote from, but in communication with, the scientific instrument 2310 so that the user may use the user local computing device 2320 to manage and/or access data from the scientific instrument 2310. In some embodiments, the user local computing device 2320 may be a laptop, smartphone, or tablet device. In some embodiments the user local computing device 2320 may be a portable computing device. In some embodiments, the user local computing device 2320 may store the application 336 and provide some or all of the user interfaces described above with respect to FIGS. 5-9 and 11-19.

The service local computing device 2330 may be a computing device (e.g., in accordance with any of the embodiments of the computing device 2200 discussed herein) that is local to an entity that services the scientific instrument 2310. For example, the service local computing device 2330 may be local to a manufacturer of the scientific instrument 2310 or to a third-party service company. In some embodiments, the service local computing device 2330 may communicate with the scientific instrument 2310, the user local computing device 2320, and/or the remote computing device 2340 (e.g., via a direct communication pathway 2308 or via multiple “indirect” communication pathways 2308, as discussed above) to receive data regarding the operation of the scientific instrument 2310, the user local computing device 2320, and/or the remote computing device 2340 (e.g., the results of self-tests of the scientific instrument 2310, calibration coefficients used by the scientific instrument 2310, the measurements of sensors associated with the scientific instrument 2310, etc.). In some embodiments, the service local computing device 2330 may communicate with the scientific instrument 2310, the user local computing device 2320, and/or the remote computing device 2340 (e.g., via a direct communication pathway 2308 or via multiple “indirect” communication pathways 2308, as discussed above) to transmit data to the scientific instrument 2310, the user local computing device 2320, and/or the remote computing device 2340 (e.g., to update programmed instructions, such as firmware, in the scientific instrument 2310, to initiate the performance of test or calibration sequences in the scientific instrument 2310, to update programmed instructions, such as software, in the user local computing device 2320 or the remote computing device 2340, etc.). A user of the scientific instrument 2310 may utilize the scientific instrument 2310 or the user local computing device 2320 to communicate with the service local computing device 2330 to report a problem with the scientific instrument 2310 or the user local computing device 2320, to request a visit from a technician to improve the operation of the scientific instrument 2310, to order consumables or replacement parts associated with the scientific instrument 2310, or for other purposes.

The remote computing device 2340 may be a computing device (e.g., in accordance with any of the embodiments of the computing device 2200 discussed herein) that is remote from the scientific instrument 2310 and/or from the user local computing device 2320. In some embodiments, the remote computing device 2340 may be included in a datacenter or other large-scale server environment. In some embodiments, the remote computing device 2340 may include network-attached storage (e.g., as part of the storage device 2304). The remote computing device 2340 may store data generated by the scientific instrument 2310, perform analyses of the data generated by the scientific instrument 2310 (e.g., in accordance with programmed instructions), facilitate communication between the user local computing device 2320 and the scientific instrument 2310, and/or facilitate communication between the service local computing device 2330 and the scientific instrument 2310. The remote computing device may perform some or all of the functions of the server 128 (e.g., supporting the server-based platform 300).

In some embodiments, one or more of the elements of the scientific instrument support system 2300 illustrated in FIG. 23 may not be present. Further, in some embodiments, multiple ones of various ones of the elements of the scientific instrument support system 2300 of FIG. 23 may be present. For example, a scientific instrument support system 2300 may include multiple user local computing devices 2320 (e.g., different user local computing devices 2320 associated with different users or in different locations). In another example, a scientific instrument support system 2300 may include multiple scientific instruments 2310, all in communication with service local computing device 2330 and/or a remote computing device 2340; in such an embodiment, the service local computing device 2330 may monitor these multiple scientific instruments 2310, and the service local computing device 2330 may cause updates or other information may be “broadcast” to multiple scientific instruments 2310 at the same time. Different ones of the scientific instruments 2310 in a scientific instrument support system 2300 may be located close to one another (e.g., in the same room) or farther from one another (e.g., on different floors of a building, in different buildings, in different cities, etc.). In some embodiments, a scientific instrument 2310 may be connected to an Internet-of-Things (IoT) stack that allows for management of the scientific instrument 2310 through a web-based application, a virtual or augmented reality application, a mobile application, and/or a desktop application. Any of these applications may be accessed by a user operating the user local computing device 2320 in communication with the scientific instrument 2310 by the intervening remote computing device 2340. In some embodiments, a scientific instrument 2310 may be sold by the manufacturer along with one or more associated user local computing devices 2320 as part of a local scientific instrument computing unit 2312.

In some embodiments, different ones of the scientific instruments 2310 included in a scientific instrument support system 2300 may be different types of scientific instruments 2310; for example, one scientific instrument 2310 may be a mass spectrometer, while another scientific instrument 2310 may be a liquid chromatography instrument. In some such embodiments, the remote computing device 2340 and/or the user local computing device 2320 may combine data from different types of scientific instruments 2310 included in a scientific instrument support system 2300.

The following paragraphs provide various examples of the embodiments disclosed herein.

According to an example embodiment disclosed above, e.g., in reference to any one or any combination of some or all of FIGS. 1-23, provided is a system comprising: first logic to acquire, for each of a plurality of scientific instrument groups, asset information associated with the scientific instrument group, the scientific instrument group including at least one scientific instrument; second logic to acquire, for each of the plurality of scientific instrument groups, reservation information associated with the scientific instrument group; third logic to generate, for each of the plurality of scientific instrument groups, a status card including status information associated with the scientific instrument group, wherein the status information is at least based on the asset information and the reservation information, and the third logic provides a first user interface for displaying the status cards.

In some embodiments of the above system, the asset information includes an instrument identifier associated with each scientific instrument included in the scientific instrument group.

In some embodiments of any of the above system, the asset information includes a scientific instrument group identifier associated the scientific instrument group.

In some embodiments of any of the above system, the asset information includes a network connection status associated with each scientific instrument group.

In some embodiments of any of the above system, the status information includes a data acquisition status of an instrument included in the scientific instrument group.

In some embodiments of any of the above system, the status information includes a plot representing the data acquisition status.

In some embodiments of any of the above system, the plot is a chromatogram.

In some embodiments of any of the above system, the first logic acquires the asset information from each scientific instrument using a network connection and an instrument listener service.

In some embodiments of any of the above system, the reservation information includes at least one selected from the group consisting of a reservation start time, a reservation end time, a reservation name, and a reservation assignee associated with an upcoming reservation of the scientific instrument group.

In some embodiments of any of the above system, the third logic provides the first user interface to a display device using a web browser.

In some embodiments of any of the above system, the at least one scientific instrument included in the scientific instrument group is a user-defined configuration.

In some embodiments of any of the above system, each of the plurality of scientific instrument groups is associated with a lab.

In some embodiments of any of the above system, the system further comprises fourth logic, wherein, in response to user selection of a status card associated with a particular scientific instrument group, the fourth logic provides a second user interface, the second user interface including at least one selected from the group consisting of: a data acquisition status of the scientific instrument group, a location of the scientific instrument group, a serial number associated with each scientific instrument included in the scientific instrument group, a model number associated with each scientific instrument included in the scientific instrument group, a firmware version associated with each scientific instrument included in the scientific instrument group, a service status associated with each scientific instrument included in the scientific instrument group, a service provided associated with each scientific instrument included in the scientific instrument group, a list of notifications associated with the scientific instrument group, and a logbook associated with the scientific instrument group.

In some embodiments of any of the above system, the logbook includes at least one logbook entry, the at least one logbook entry including at least one selected from the group consisting of: a support request, a software update, a configuration update, and a performed operation associated with a scientific instrument included in the scientific instrument group.

In some embodiments of any of the above system, the system further comprises fifth logic to provide a third user interface for generating a support ticket associated with a particular scientific instrument included in the scientific instrument group, the third user interface including a user-selectable list of scientific instruments included in the scientific instrument group, wherein the particular scientific instrument is selected from the user-selectable list, and the support ticket includes the asset information associated with the particular scientific instrument.

In some embodiments of any of the above system, the system further comprises sixth logic to provide a fourth user interface, the fourth user interface including a reservation schedule of each of the plurality of scientific instrument groups.

In some embodiments of any of the above system, the sixth logic generates a new reservation for a user-selected scientific instrument group, the new reservation including at least one selected from the group consisting of: a reservation date, a start time, an end time, an operation, a reservation assignee, and a selection of a full reservation or partial reservation.

In some embodiments of any of the above system, the sixth logic determines a suggested assignee based on at least one selected from the group consisting of: the reservation date, the start time, the end time, and the operation.

In some embodiments of any of the above system, the sixth logic determines a suggested start time based on at least one selected from the group consisting of: the reservation date and the operation.

In some embodiments of any of the above system, the sixth logic determines a suggested end time based on at least one selected from the group consisting of: the reservation date and the operation.

In some embodiments of any of the above system, based on the reservation assignee and the operation, the sixth logic determines at least one selected from the group consisting of: a suggested start time, a suggested end time, and a suggested reservation date.

In some embodiments of any of the above system, the sixth logic generates a reminder notification based on the reservation date and the start time and provides the reminder notification to the reservation assignee.

In some embodiments of any of the above system, the sixth logic generates a reminder notification based on the reservation date and the end time and provides the reminder notification to the reservation assignee.

In some embodiments of any of the above system, the sixth logic determines a suggested maintenance reservation of a scientific instrument based on the reservation schedule and a usage history of the scientific instrument.

In some embodiments of any of the above system, the system further comprises seventh logic to selectively enable and disable modification of the reservation schedule according to user privilege.

In some embodiments of any of the above system, the second logic, and the third logic are implemented by a common computing device.

In some embodiments of any of the above system, at least one of the first logic, the second logic, and the third logic are implemented by a computing device remote from the at least one scientific instrument.

In some embodiments of any of the above system, at least one of the first logic, the second logic, and the third logic are implemented by a user computing device.

In some embodiments of any of the above system, at least one of the first logic, the second logic, and the third logic are implemented in the at least one scientific instrument.

According to another example embodiment disclosed above, e.g., in reference to any one or any combination of some or all of FIGS. 1-23, provided is a system comprising: first logic to acquire, for each of the plurality of scientific instrument groups, reservation information associated with the scientific instrument group; second logic to aggregate the reservation information of each of the plurality of scientific instrument groups to create an aggregated schedule; third logic to provide a first user interface for display to a display device, the first user interface including the aggregated schedule of each of the plurality of scientific instrument groups in separate regions of the first user interface, wherein each of the plurality of scientific instrument groups includes at least one scientific instrument.

In some embodiments of any of the above system, each region of the aggregated schedule represents a plurality of time slots and wherein each of the plurality of time slots is marked as an unreserved time slot or a reserved time slot.

In some embodiments of any of the above system, the third logic displays, in response to receiving user input indicating a selection of a reserved time slot of a scientific instrument group, reservation details associated with a reservation of the scientific instrument group during the reserved time slot.

In some embodiments of any of the above system, the reservation details include a plurality of reservation fields, the plurality of reservation fields including at least two selected form the group consisting of: a maintenance reservation field, a project name, a reservation name, a scientific instrument group identifier, identifiers of scientific instruments included in the scientific instrument group, a start time of the reservation, an end time of the reservation, a start date of the reservation, an end date of the reservation, a recurrence of the reservation, a description of the reservation, and a reservation assignee of the reservation.

In some embodiments of any of the above system, in response to user selection of one of the plurality of reservation fields, the third logic determines whether the user has sufficient user privilege to modify the selected field, and in response to determining that the user has sufficient user privilege to modify the selected field, modify the selected field according to user input.

In some embodiments of any of the above system, the reservation assignee is user-selectable from a drop down menu.

In some embodiments of any of the above system, the recurrence is user-selectable from a drop down menu, and the recurrence includes at least one selected from the group consisting of a daily recurrence, a weekly recurrence, a monthly recurrence, a quarterly recurrence, a yearly recurrence, and no recurrence.

In some embodiments of any of the above system, the system further comprises fourth logic to disable modification of the reservation in response to determining that the user does not have sufficient user privilege to modify the reservation.

In some embodiments of any of the above system, in response to a user dragging a reservation of a reserved time slot of a scientific instrument group to a different time slot, the third logic modifies a start time and an end time of the reservation according to the different time slot.

In some embodiments of any of the above system, in response to user input indicating a creation of a new reservation, the third logic displays an instrument search field including a list of scientific instruments and determines a scientific instrument group for the new reservation based on user selection of at least one scientific instrument included in the instrument search field.

In some embodiments of any of the above system, the third logic determines the scientific instrument group for the new reservation based on user selection in response to determining that the user has sufficient user privilege to select the at least one instrument.

1. A scientific instrument support system, comprising:
first logic to acquire, for each of a plurality of scientific instrument groups, asset information associated with the scientific instrument group, the scientific instrument group including at least one scientific instrument;
second logic to acquire, for each of the plurality of scientific instrument groups, reservation information associated with the scientific instrument group;
third logic to generate, for each of the plurality of scientific instrument groups, a status card including status information associated with the scientific instrument group, wherein the status information is at least based on the asset information and the reservation information, and the third logic provides a first user interface for displaying the status cards.

2. The scientific instrument support system of claim 1, wherein the asset information includes at least one selected from a group consisting of an instrument identifier associated with each scientific instrument included in the scientific instrument group, a scientific instrument group identifier associated the scientific instrument group, and a network connection status associated with each scientific instrument group.

3. The scientific instrument support system of claim 1, wherein the status information includes at least one selected from a group consisting of a data acquisition status of an instrument included in the scientific instrument group and a plot representing the data acquisition status.

4. The scientific instrument support system of claim 1, wherein the first logic acquires the asset information from each scientific instrument using a network connection and an instrument listener service.

5. The scientific instrument support system of claim 1, wherein the reservation information includes at least one selected from the group consisting of a reservation start time, a reservation end time, a reservation name, and a reservation assignee associated with an upcoming reservation of the scientific instrument group.

6. The scientific instrument support system of claim 1, wherein the at least one scientific instrument included in the scientific instrument group is a user-defined configuration.

7. The scientific instrument support system of claim 1, further comprising fourth logic, wherein, in response to user selection of a status card associated with a particular scientific instrument group, the fourth logic provides a second user interface, the second user interface including at least one selected from the group consisting of: a location of the scientific instrument group, a serial number associated with each scientific instrument included in the scientific instrument group, a model number associated with each scientific instrument included in the scientific instrument group, a firmware version associated with each scientific instrument included in the scientific instrument group, a service status associated with each scientific instrument included in the scientific instrument group, a service provided associated with each scientific instrument included in the scientific instrument group, a list of notifications associated with the scientific instrument group, and a logbook associated with the scientific instrument group.

8. The scientific instrument support system of claim 7, wherein the logbook includes at least one logbook entry, the at least one logbook entry including at least one selected from the group consisting of: a support request, a software update, a configuration update, and a performed operation associated with a scientific instrument included in the scientific instrument group.

9. The scientific instrument support system of claim 7, further comprising:
fifth logic to provide a third user interface for generating a support ticket associated with a particular scientific instrument included in the scientific instrument group, the third user interface including a user-selectable list of scientific instruments included in the scientific instrument group,
wherein the particular scientific instrument is selected from the user-selectable list, and the support ticket includes the asset information associated with the particular scientific instrument.

10. The scientific instrument support system of claim 1, further comprising fourth logic to provide a fourth user interface, the fourth user interface including a reservation schedule of each of the plurality of scientific instrument groups.

11. The scientific instrument support system of claim 10, wherein
the fourth logic generates a new reservation for a user-selected scientific instrument group, the new reservation including at least one selected from the group consisting of: a reservation date, a start time, an end time, an operation, a reservation assignee, and a selection of a full reservation or partial reservation.

12. The scientific instrument support system of claim 10, wherein the fourth logic generates a reminder notification for a reservation included in the reservation schedule for one of the plurality of scientific groups and provides the reminder notification to an assignee associated with the reservation.

13. The scientific instrument support system of claim 10, further comprising fifth logic to selectively enable and disable modification of the reservation schedule according to user privilege.

14. A scientific instrument support system comprising:
first logic to acquire, for each of the plurality of scientific instrument groups, reservation information associated with the scientific instrument group;
second logic to aggregate the reservation information of each of the plurality of scientific instrument groups to create an aggregated schedule;
third logic to provide a first user interface for display to a display device, the first user interface including the aggregated schedule of each of the plurality of scientific instrument groups in separate regions of the first user interface, wherein each of the plurality of scientific instrument groups includes at least one scientific instrument.

15. The scientific instrument support system of claim 14, wherein each region of the aggregated schedule represents a plurality of time slots and wherein each of the plurality of time slots is marked as an unreserved time slot or a reserved time slot.

16. The scientific instrument support system of claim 14, wherein
the third logic displays, in response to receiving user input indicating a selection of a reserved time slot of a scientific instrument group, reservation details associated with a reservation of the scientific instrument group during the reserved time slot.

17. The scientific instrument support system of claim 16, wherein the reservation details include a plurality of reservation fields, the plurality of reservation fields including a start time of the reservation, an end time of the reservation, a start date of the reservation, an end date of the reservation, and a reservation assignee of the reservation.

18. The scientific instrument support system of claim 16, wherein the reservation details includes a recurrence, the recurrence including at least one selected from the group consisting of a daily recurrence, a weekly recurrence, a monthly recurrence, a quarterly recurrence, a yearly recurrence, and no recurrence.

19. The scientific instrument support system of claim 14, further comprising:
fourth logic to disable modification of the reservation in response to determining that the user does not have sufficient user privilege to modify the reservation.

20. The scientific instrument support system of claim 14, wherein
in response to user input indicating a creation of a new reservation, the third logic displays an instrument search field including a list of scientific instruments and determines a scientific instrument group for the new reservation based on user selection of at least one scientific instrument included in the instrument search field.
